(19) United States
(12) Patent Application Publication
(10) Pub. No.: US 2023/0385707 A1
(43) Pub. Date: Nov. 30, 2023

(54) SYSTEM FOR MODELLING A DISTRIBUTED COMPUTER SYSTEM OF AN ENTERPRISE AS A MONOLITHIC ENTITY USING A DIGITAL TWIN

(71) Applicant: Accenture Global Solutions Limited, Dublin 4 (IE)

(72) Inventors: Debashish Roy, Covina, CA (US); Cory King, Calgary, CA (US); Brent Shaffer, San Diego, CA (US)

(21) Appl. No.: 17/825,481

(22) Filed: May 26, 2022

(51) Int. Cl. G06N 20/20

(52) U.S. Cl. CPC G06N 20/20

(57) ABSTRACT

Aspects of the present disclosure provide systems, methods, apparatus, and computer-readable storage media that support creating and leveraging digital twins to model multiple physical systems of an enterprise as a monolithic computer system. A digital twin platform may create an abstracted virtual model of an enterprise's system, the model representing a digital twin of a distributed collection of systems that as a group serve a larger goal of the enterprise. Because the abstracted virtual model is logically organized as a monolithic system that maps to multiple physical systems, the abstracted virtual model may be leveraged to provide system health monitoring and scoring from data gathered from the physical systems. The health monitoring, in addition to generation of insights for improving system health, may be easier to understand and more familiar to a user, thereby enabling meaningful determination of actions to perform to maintain or improve system health.

### TECHNICAL FIELD

The present disclosure relates generally to system modelling, and more particularly, to using a digital twin to model a plurality of physical computer systems as a monolithic entity using agent-based machine learning.

### BACKGROUND

Presently, enterprises across many different industries are seeking to incorporate the use of digital twins to test, streamline, or otherwise evaluate various aspects of their operations. One such industry is the automotive industry, where digital twins have been explored as a means to analyze and evaluate performance of a vehicle. To illustrate, the use of digital twins has been explored as a means to safely evaluate performance of autonomous vehicles in mixed driver environments (i.e., environments where autonomous vehicles are operating in the vicinity of human drivers). As can be appreciated from the non-limiting example above, the ability to analyze performance or other factors using a digital twin, rather than its real world counterpart (e.g., the vehicle represented by the digital twin), can provide significant advantages. Although the use of digital twins has proved useful across many different industries, digital twins are typically used to provide a digital representation of a single real-world element or systems, such as an autonomous vehicle, a building, a production flow, or the like.

Challenges remain with extending the use of digital twins beyond the above-described examples. One such challenge is in the context of modelling a distributed system. Different digital twins may be used to model each of the components of the system, but such modelling may not provide the desired insights into the dependencies and relationships between the various components. Additionally, barriers between isolated groups of components may make modelling the overall system challenging. Another problem is that a digital twin may model a real-world system, but the system may work together with other elements of the enterprise, such as people, resources, and the like, to achieve a larger goal (e.g., a business objective). Further, a model that is too tightly coupled to an enterprise's processes may be difficult to adapt to changes. Without taking into account the larger context and without being sufficiently adaptable, the utility of a digital twin may be limited.

### SUMMARY

Aspects of the present disclosure provide systems, methods, and computer-readable storage media that support creation and leveraging of digital twins to model multiple physical systems of an enterprise as a monolithic entity to provide enhanced monitoring and insights. The systems and techniques described herein enable generation of an abstracted virtual model of an enterprise's computing system that has multiple physical systems, such as a distributed system that includes on-premises devices, cloud-based applications, mobile devices, sensors, Internet of Things (IoT) devices, and the like. The abstracted virtual model is logically organized as a monolithic system that includes a plurality of components that map to the multiple physical systems, such that the abstracted virtual model represents a digital twin of a monolithically organized computing system of the enterprise. By modelling the multiple physical systems as a monolithic system, the abstracted virtual model may be leveraged to provide system health monitoring and insights, such as highly correlated operations that strongly affect system health, that would otherwise by difficult or impossible using digital twins of the individual physical systems or the distributed system.

In order to support the system health monitoring and insight functionality, monitoring data obtained from the multiple physical systems is mapped to input data of the abstracted virtual model. In some implementations, the mapping is performed using one or more machine learning (ML) models, such as an ensemble of particular ML models. The ensemble ML model may leverage multiple ML models that are trained to perform the mapping based on different parameters, such as relationships between data values, similarity scores, and associations. In some implementations, an agent may be configured to recommend actions to improve the mapping performed by the ML model(s), thereby providing a self-organizing agent-based ML framework for mapping outputs of the multiple physical systems to inputs of the abstracted virtual model. For example, the agent may be a reinforcement learning (RL) agent that uses a reward function to recommend actions, such as adding a particular mapping, removing a particular mapping, modifying a particular mapping, or the like, to improve performance of the ML model(s). The improvement can be tailored to one or more target parameters through configuration of the reward function, such that performance may be improved with respect to system health coverage, validation error, calculation error, quantity of missing data, or the like.

The aspects disclosed herein provide benefits as compared to other digital twins of computer systems. For example, by modelling multiple physical systems as an abstracted virtual model of a single monolithically-organized system, relationships and dependencies between various computer systems that are isolated may be identified and leveraged to determine system health at a variety of granularities. Additionally, insights such as highly correlated parameters or events may be identified, particularly ones that have a strong effect on system health, that would otherwise go unidentified without the logical organization of the abstracted virtual model. The system health monitoring and insights provided by the abstracted virtual model also take into account the relationship of the physical systems to the operations of the whole, such that the abstracted virtual model acts as a digital twin of a monolithic computer system and represents the relationship between the system and the enterprise as a whole (e.g., in view of business objectives, key performance indicators, and the like). Thus, the insights and information that are based on the abstracted virtual model enable members of the enterprise to make more meaningful decisions to improve system health, achieve enterprise goals, or the like. In some implementations, the outputs of the physical systems are mapped to input data for the abstracted virtual model using agent-controlled ML models, such that the mappings are adaptable to changing situations and to improve performance of the abstracted virtual model with respect to one or more targets. As such, the mapping of output data (e.g., monitoring data) to input data for the abstracted virtual model may have improved performance as compared to using a static, predefined mapping, without requiring periodic updating of the ML models by a data scientist or other technician.

In a particular aspect, a method for creating and leveraging digital twins of physical systems of enterprises includes generating, by one or more processors, an abstracted virtual model of a computing system of an enterprise. The abstracted virtual model corresponds to a plurality of physical systems of the enterprise that are communicatively coupled via one or more networks. The abstracted virtual model is logically organized as a monolithic system comprising a plurality of components that are mapped to the plurality of physical systems. The abstracted virtual model defines relationships, dependencies, and attributes corresponding to the plurality of components. The method also includes obtaining, by the one or more processors, monitoring data from the plurality of physical system. The method includes mapping, by the one or more processors, the monitoring data to input data to update the plurality of components of the abstracted virtual model. The method further includes outputting, by the one or more processors, health scores corresponding to one or more components of the abstracted virtual model after the update.

In another particular aspect, a system for creating and leveraging digital twins of physical systems of enterprises includes a memory and one or more processors communicatively coupled to the memory. The one or more processors are configured to generate an abstracted virtual model of a computing system of an enterprise. The abstracted virtual model corresponds to a plurality of physical systems of the enterprise that are communicatively coupled via one or more networks. The abstracted virtual model is logically organized as a monolithic system comprising a plurality of components that are mapped to the plurality of physical systems. The abstracted virtual model defines relationships, dependencies, and attributes corresponding to the plurality of components. The one or more processors are also configured to obtain monitoring data from the plurality of physical system. The one or more processors are configured to map the monitoring data to input data to update the plurality of components of the abstracted virtual model. The one or more processors are further configured to output health scores corresponding to one or more components of abstracted virtual model after the update.

In another particular aspect, a non-transitory computer-readable storage medium stores instructions that, when executed by one or more processors, cause the one or more processors to perform operations for creating and leveraging digital twins of physical systems of enterprises. The operations include generating an abstracted virtual model of a computing system of an enterprise. The abstracted virtual model corresponds to a plurality of physical systems of the enterprise that are communicatively coupled via one or more networks. The abstracted virtual model is logically organized as a monolithic system comprising a plurality of components that are mapped to the plurality of physical systems. The abstracted virtual model defines relationships, dependencies, and attributes corresponding to the plurality of components. The operations also include obtaining monitoring data from the plurality of physical system. The operations include mapping the monitoring data to input data to update the plurality of components of the abstracted virtual model. The operations further include outputting health scores corresponding to one or more components of abstracted virtual model after the update.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports creating and leveraging digital twins of physical systems of enterprises according to one or more aspects;

FIG. 2 is a block diagram of an example of a system that supports a digital twin of a computer system of an enterprise according to one or more aspects;

FIG. 3 is a block diagram of another example of a system that supports a digital twin of a computer system of an enterprise according to one or more aspects;

FIG. 4 is a block diagram of an example of a system that supports an agent-based machine learning (ML) framework for mapping outputs of a physical system to a digital twin according to one or more aspects;

FIG. 5 illustrates a process flow of an example of a method for mapping output fields to input fields based on association and a related example according to one or more aspects;

FIG. 6 illustrates a process flow of an example of a method for mapping output fields to input fields based on similarity and a related example according to one or more aspects;

FIG. 7 illustrates a process flow of an example of a method for mapping output fields to input fields based on data values and a related example according to one or more aspects:

FIG. 8 illustrates a process flow of an example of a method for mapping output fields to input fields based on an ensemble model and a related example according to one or more aspects;

FIG. 9 is a block diagram of an example of a system that uses an abstracted virtual model of a monolithic system to provide reporting and a system health tree according to one or more aspects;

FIG. 10 is a block diagram of an example of a system that generates health scores and a system health tree based on an abstracted virtual model according to one or more aspects:

FIG. 11 shows an example of a system health graphical user interface (GUI) according to one or more aspects;

FIG. 12 is a block diagram of an example of a system that uses an abstracted virtual model of a monolithic system to generate system health insights according to one or more aspects;

FIG. 13 shows an example of providing health system insights according to one or more aspects; and

FIG. 14 is a flow diagram illustrating an example of a method for creating and leveraging digital twins of physical systems of enterprises according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that support creating and leveraging digital twins to model multiple physical systems of enterprises as monolithic computer systems. To illustrate, a digital twin platform may create an abstracted virtual model of an enterprise's information technology (IT) system (e.g., a computing system that includes multiple physical devices or systems). The abstracted virtual model represents a digital twin of a distributed collection of systems that as a group serve a larger goal of the enterprise (e.g., a business, an organization, or another type of entity), such as one or more business objectives. Because the abstracted virtual model is logically organized as a monolithic system that includes a plurality of components that map to the multiple physical systems, the abstracted virtual model may be leveraged to provide system health monitoring and scoring from data gathered from the model. Additionally, key performance indicator (KPI) information may be mined from the abstracted virtual model to identify highly correlated information and to generate insights for improving system health. In some implementations, output data (e.g., monitoring data) from the multiple physical systems may be mapped to input data for the abstracted virtual model using an ensemble of differently trained ML models instead of a predefined mapping structure, which may improve adaptability of the mapping to changes in circumstances at the physical systems. Additionally, in some implementations, a reinforcement learning (RL) agent may suggest actions to improve the performance of the mapping performed by the ML models with respect to one or more target parameters, increasing performance and providing real time (or near-real time) mapping capabilities as compared to static mapping structures or algorithms.

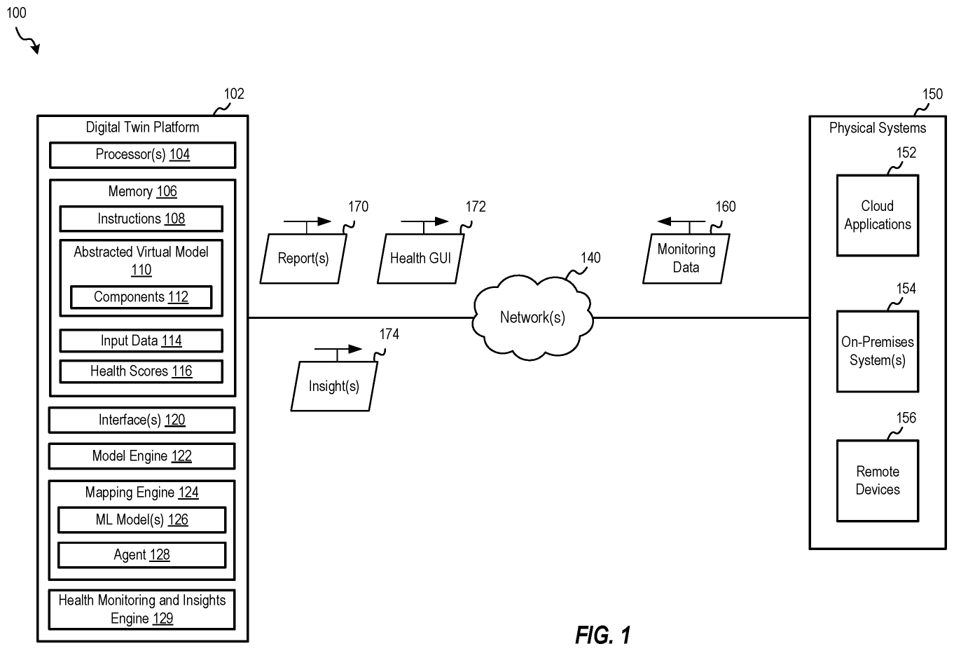

Referring to FIG. 1, an example of a system for creating and leveraging digital twins of physical systems of enterprises according to one or more aspects is shown as a system 100. As shown in FIG. 1, the system 100 includes a digital twin platform 102, multiple physical systems 150, and one or more networks 140. In some implementations, the system 100 may include additional components that are not shown in FIG. 1, such as one or more client devices, additional physical systems, and/or a database configured to store health scores, reports, insights, mappings fields of output data to fields of input data, ML model parameters, performance indicator datasets, or a combination thereof, as non-limiting examples.

The digital twin platform 102 may be configured to create and maintain abstracted virtual models of physical systems (e.g., real world systems), including distributed systems, and to leverage these models for reporting, monitoring system health, and providing insights. In some implementations, the digital twin platform 102 may include or correspond to a server, desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The digital twin platform 102 includes one or more processors 104, a memory 106, one or more communication interfaces 120, a model engine 122, a mapping engine 124, and a health monitoring and insights engine 129. In some other implementations, one or more of the components may be optional, one or more additional components may be included in the digital twin platform 102, or both. It is noted that functionalities described with reference to the digital twin platform 102 are provided for purposes of illustration, rather than by way of limitation, and that the exemplary functionalities described herein may be provided via other types of computing resource deployments. For example, in some implementations, computing resources and functionality described in connection with the digital twin platform 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the digital twin platform 102 may be performed by one or more servers or a cloud-based system that communicates with one or more client or user devices.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the digital twin platform 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the digital twin platform 102 may be stored in the memory 106 as instructions 108 that, when executed by the one or more processors 104, cause the one or more processors 104 to perform the operations described herein with respect to the digital twin platform 102, as described in more detail below. Additionally, the memory 106 may be configured to store data and information, such as an abstracted virtual model 110, input data 114, and health scores 116. Illustrative aspects of the abstracted virtual model 110, the input data 114, and the health scores 116 are described in more detail below.

The one or more communication interfaces 120 may be configured to communicatively couple the digital twin platform 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the digital twin platform 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the digital twin platform 102. In some implementations, the digital twin platform 102 is coupled to a display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the digital twin platform 102. In some other implementations, the digital twin platform 102 is communicatively coupled to one or more client devices that include or are coupled to respective display devices.

The model engine 122 is configured to create and maintain abstracted virtual models of physical systems (e.g., real world systems), such as abstracted virtual models that act as digital twins for physical systems. In some implementations, the abstracted virtual models created and maintained by the model engine 122 are logically organized as monolithic systems even though they are used to model multiple physical systems, such as a distributed system across multiple locations, devices, and/or applications. To illustrate, the abstracted virtual models maintained by the model engine 122 differ from conventional digital twins at least in that the abstracted virtual models described herein are organized according to a different logical organization (e.g., a monolithic entity) than the physical systems that are being modelled. In some implementations, the abstracted virtual models may include multiple components, and each component of the model may correspond to operations performed by one or more than one elements of the physical systems being modelled. The model engine 122 may be configured to provide the abstracted virtual models with input data that is mapped from monitored data of the physical systems for use in performing one or more operations described further herein, such as generating health scores, outputting a system health tree, outputting one or more reports, generating one or more system health insights, or the like.

The mapping engine 124 is configured to map monitoring data (e.g., output data, operation data, parameters, configurations, etc.) from multiple physical systems to input data of abstracted virtual models. In some implementations, the monitoring data may be mapped to the input data on a field by field basis, as further described herein. To support real time (or near-real time) mapping of monitoring data to input data, the mapping engine 124 may include, implement, or have access to one or more machine learning (ML) or artificial intelligence (AI) models, referred to herein as “ML models 126.” The ML models 126 may include or correspond to one or more neural networks (NNs), such as multi-layer perceptron (MLP) networks, convolutional neural networks (CNNs), recurrent neural networks (RNNs), deep neural networks (DNNs), long short-term memory (LSTM) NNs, or the like, support vector machines (SVMs), decision trees, random forests, regression models, Bayesian networks (BNs), dynamic Bayesian networks (DBNs), naive Bayes (NB) models, Gaussian processes, hidden Markov models (HMMs), regression models, or the like. In some implementations, the ML models 126 may include an ensemble model that selects an output from multiple ML models trained to perform mapping based on different parameters or characteristics, or using different training datasets, as further described herein. In some implementations, the mapping engine 124 includes an agent 128 that is configured to recommend actions to improve the performance of the ML models 126. For example, the agent 128 may be a reinforcement learning (RL) model that uses a reward function to determine recommended actions, such as adding mappings, removing mappings, or modifying mappings, to be performed by the ML models 126.

The health monitoring and insights engine 129 is configured to process mapped input data and abstracted virtual models to monitor health of the systems represented by the abstracted virtual models. The health monitoring may include generating one or more outputs, such as reports, health scores, health trees, insights, or the like. For example, the health monitoring and insights engine 129 may be configured to generate a health tree, such as a graphical user interface (GUI) that displays overall system health and component-level system health for a system represented by an abstracted virtual model. Additionally or alternatively, the health monitoring and insights engine 129 may be configured to generate one or more health insights based on information derived from processing the monitoring data and the abstracted virtual model. To illustrate, the health monitoring and insights engine 129 may be configured to analyze transactions, events, or the like, that correspond to components of an abstracted virtual model to identify highly correlated data pairs (e.g., transaction pairs, event pairs, etc.). The highly correlated data pairs may be prioritized based on their effect on overall system health, and the health monitoring and insights engine 129 may be configured to generate the insights based on high priority highly correlated data pairs. The insights may include text descriptions of relations between the transactions or events of the identified prioritized highly correlated data pairs and/or their relation to system health. In some implementations, the health monitoring and insights engine 129 may be configured to perform one or more natural language processing (NLP) operations on identifiers of the transactions or events to generate the insights. Additionally or alternatively, the health monitoring and insights engine 129 may be configured to apply one or more predefined insight templates to the prioritized highly correlated data pairs to generate the insights.

The physical systems 150 include multiple (e.g., a plurality of) physical systems that are coupled together by one or more networks and that are configured to operate as an information technology (IT) system for an enterprise. For example, the physical systems 150 may include or correspond to multiple devices, systems, applications, micro systems, or other elements that are configured to perform individual operations and, when viewed as a collection, perform one or more larger roles for the enterprise, such as one or more business objectives. As technology has advanced, enterprises are transitioning from owning and maintaining all of their IT systems to implementing more distributed architectures across multiple locations and technology types. For example, as compared to in the past when an enterprise may have implemented computers at on-premises locations to meet all of their technology needs, enterprises of today are increasingly migrating operations to cloud service providers as well as integrating newer types of devices, such as smart phones and IoT devices, into their computing environment. As such, the physical systems 150 may include or correspond to many different types of distributed system architectures. Each of the different physical systems may be isolated, or partially isolated, from each other and, in some implementations, controlled or maintained by multiple different entities including the enterprise, cloud service providers, employees, customers, contractors, or the like.

In some implementations, the physical systems 150 include cloud applications 152, on-premises systems 154, and remote devices 156. Although three specific types of physical systems are shown in FIG. 1, in other implementations, the physical systems 150 may include fewer than three or more than three physical systems (or types of systems or devices), different types of physical systems than shown in FIG. 1, or a combination thereof. The cloud applications 152 may include one or more services or applications provided by one or more cloud service providers (CSPs), such as cloud storage, cloud processing, cloud-based ML or AI services, other services, or a combination thereof. The on-premises systems 154 may include one or more computing systems located on the premises of the enterprise, such as desktop computers, laptop computers, servers, hub devices, electronic assembly lines, electronic tools, other technology, or a combination thereof. The remote devices 156 may include one or more mobile devices or devices located off-site of the premises of the enterprise, such as smart phones, smart watches, wireless sensors, autonomous vehicles, robots, IoT devices, other devices, or a combination thereof.

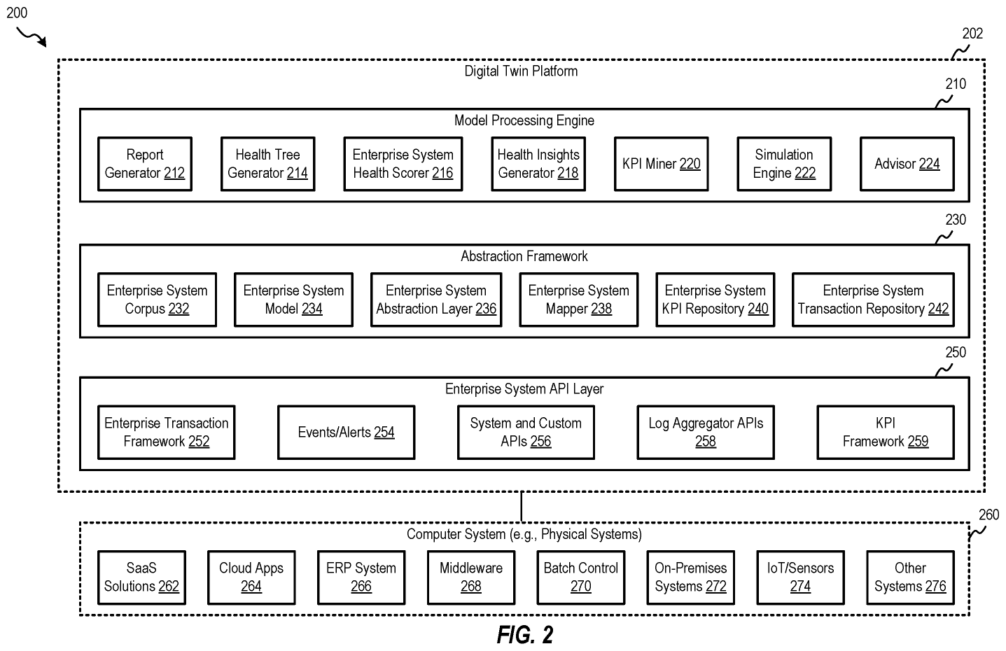

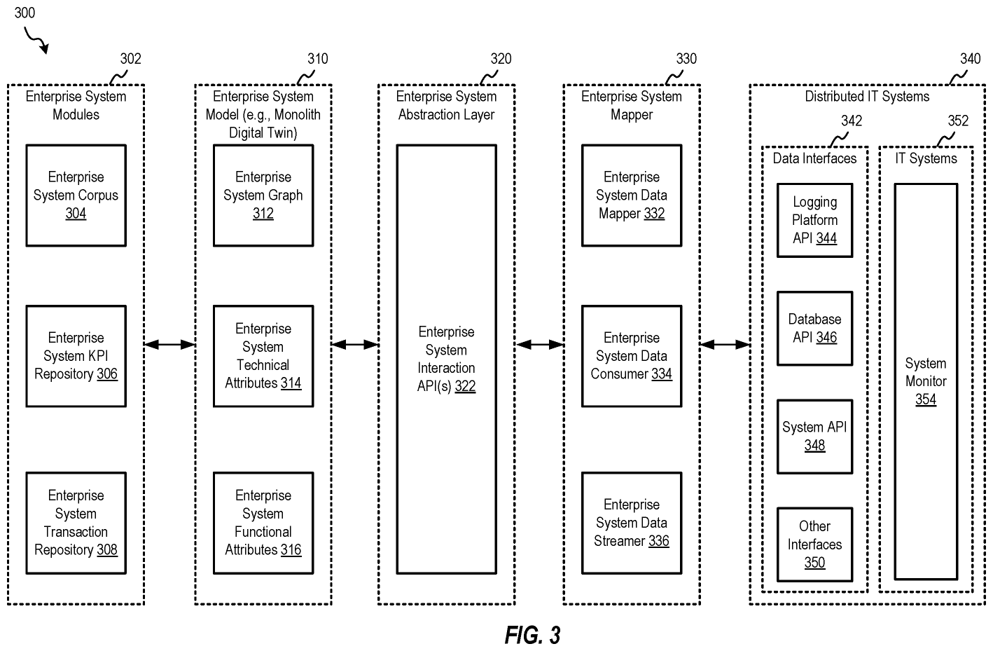

During operation of the system 100, the digital twin platform 102 may create (e.g., generate) an abstracted virtual model 110 that represents the physical systems 150. For example, the model engine 122 may receive or access an enterprise system corpus (e.g., a repository of enterprise structure, functions, and systems that contains details relating data from various granularities of the enterprise to key performance indicators (KPIs) and enterprise transactions), an enterprise KPI repository (e.g., a collection of relevant enterprise system KPIs and their definitions and relationships to each other and the enterprise), and an enterprise system transaction repository (e.g., a collection of relevant or predicted enterprise transactions) to generate the abstracted virtual model 110, as further described below with reference to FIGS. 2-3. The abstracted virtual model may be logically organized as a monolithic system instead of as multiple, distinct systems that also work together as a collective. To illustrate, the abstracted virtual model 110 may model a monolithic IT system that includes multiple (e.g., a plurality of) components 112 that are mapped to the physical systems 150. The components 112 of the abstracted virtual model 110 may be mapped to the individual members of the physical systems 150 on a one-to-one, one-to-many, or many-to-one basis, such that operations performed by a component of the abstracted virtual model 110 may be performed by a single device or multiple devices of the physical systems 150. Stated another way, the abstracted virtual model 110 may represent a digital twin of a monolithically organized computing system that corresponds to the physical systems 150 (e.g., a model of a monolithic IT system that performs all the operations and functionality of physical systems 150 but is not distributed into a collection of multiple distinct physical systems). The abstracted virtual model 110 may define relationships, dependencies, and attributes corresponding to the components 112 that make up the model. The relationships and dependencies may determine how outputs and/or operations of some components affect the other components, and the attributes may enable monitoring of the system modelled by the abstracted virtual model 110. To illustrate, one or more attributes of the components 112 may be exposed by one or more application programming interfaces (APIs), which enables real time (or near-real time) updating of the attributes based on information from the physical systems 150, which in turn updates the overall abstracted virtual model 110. For example, the abstracted virtual model 110 may include an API layer configured to update the components 112 based on input data, as further described herein with reference to FIGS. 2-4.

The digital twin platform 102 may obtain monitoring data 160 from the physical systems 150. The monitoring data 160 may include output data from the physical systems 150, operation data from the physical systems 150, other data or parameters, or a combination thereof. For example, the monitoring data 160 may include or indicate operations performed by the physical systems 150 during a time period, various counts or measurements recorded by the physical systems 150 during the time period, errors detected by the physical systems 150 during the time period, resource use by the physical systems 150 during the time period, incident reports to the physical systems 150 during the time period, customer tool usage of tools supported by the physical systems 150 during the time period, account users of the physical systems 150 during the time period, other information, or a combination thereof. In some implementations, the monitoring data 160 may be streaming data that is provided by the physical systems 150. Alternatively, the monitoring data 160 may be periodically provided by the physical systems 150 or on-request to the digital twin platform 102. In some implementations, the digital twin platform 102 may perform one or more filtering or transformation operations on at least a portion of the monitoring data 160 to convert the monitoring data 160 to a common format used by the mapping engine 124.

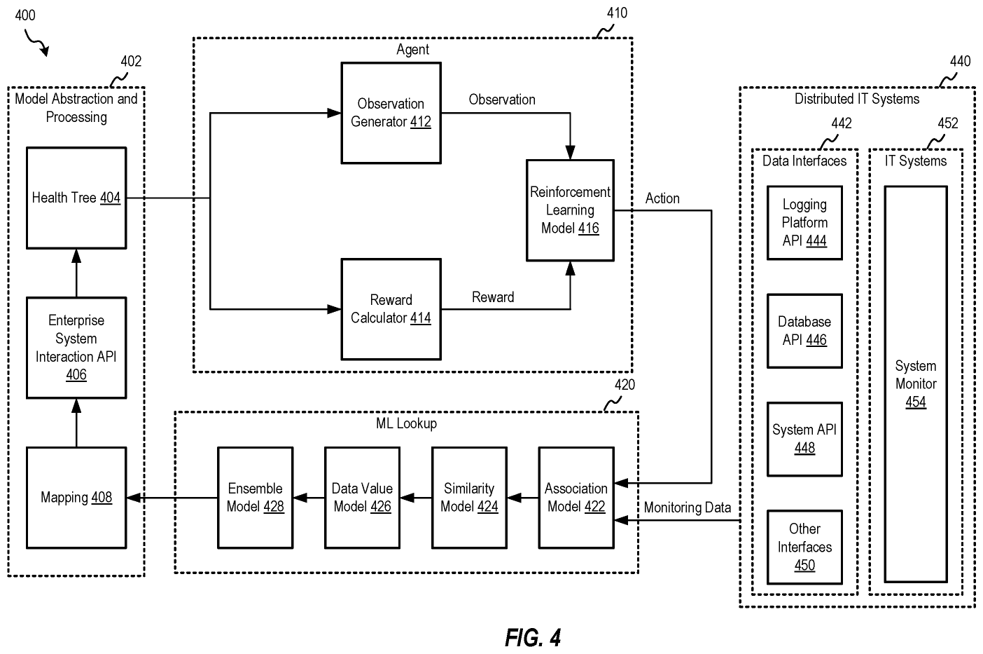

To use the monitoring data 160 to update the abstracted virtual model 110, the digital twin platform 102 may provide the monitoring data 160 to the mapping engine 124 for mapping of the monitoring data 160 to input data 114. For example, the mapping engine 124 may map one or more fields of the monitoring data 160 to one or more fields of the input data 114 that can be processed with the abstracted virtual model 110. As a non-limiting example, if the monitoring data 160 includes a field that represents returned (e.g., bounce back) emails and the abstracted virtual model 110 includes a component that counts emails transmitted with an incorrect address, the mapping engine 124 may map the returned emails field of the monitoring data 160 to an incorrect address count field of the input data 114 based on commonalities between the two fields, as further described herein. The mapping may be performed dynamically using machine learning instead of a static mapping algorithm or configuration. To illustrate, to map the monitoring data 160 to the input data 114, the mapping engine 124 provides the monitoring data 160 to the ML models 126. The ML models 126 include one or more trained ML models that are trained to map fields of monitoring data to fields of input data for the abstracted virtual model 110. In some implementations, the ML models 126 include or correspond to an ensemble model that is trained to output a recommendation based on recommendations output by multiple ML models that are trained to recommend mappings based on different characteristics or parameters. As a particular example, the ML models 126 may include an ensemble model configured to output a mapping recommendation based on recommendations from three differently trained ML models: a data value ML model, a similarity ML model, and an association ML model (e.g., ML models trained to recommend mappings based on data value matching between fields, similarity between fields, and association between fields, respectively). Additional details of this example are further described herein with reference to FIG. 4. In other examples, the ML models 126 may include an ensemble model that selects a recommendation based on recommendations of fewer than three or more than three ML models, ML models that are trained differently than described above, or a combination thereof.

In some implementations, the mapping engine 124 includes the agent 128, and the mapping engine 124 may provide one or more outputs based on the abstracted virtual model 110 as input to the agent 128 to determine an action to take to improve the mapping performed by the ML models 126. For example, the agent 128 may include or correspond to a reinforcement learning (ML) model that learns to recommend actions based on a reward function. The reward function is based on one or more target parameters selected for improving the performance of the mappings recommended by the ML models 126. For example, the reward function may be based on calculation error associated with the one or more outputs based on the abstracted virtual model 110, missing data associated with the one or more outputs, validation error associated with the one or more outputs, coverage scope associated with the one or more outputs, or a combination thereof. The action recommended by the agent 128 may modify a mapping-related action that would otherwise be taken by the ML models 126. For example, the action may include adding a mapping of a field of the monitoring data 160 to a field of the input data 114, removing the mapping of the field of the monitoring data 160 to the field of the input data 114, modifying the mapping of the field of the monitoring data 160 to the field of the input data 114, or taking no action (e.g., maintaining the current mappings). Additional details of operation of an agent-based ML architecture for mapping monitoring data to input data is described below with reference to FIG. 4.

After mapping the monitoring data 160 to the input data 114, the digital twin platform 102 may process the input data 114 with the abstracted virtual model 110 to monitor the health or operation of the IT system (e.g., the monolithic model representing the physical systems 150) in real time (or near-real time) and to derive insights or predictions of relationships of transactions of the IT system for providing output to a user to provide a holistic and easily-interpretable understanding of a current state of the physical systems 150 both from an operational perspective and a larger enterprise-centric perspective (e.g., with reference to one or more business objectives). To support such functionality, the digital twin platform 102 may determine the health scores 116 that correspond to a health of the system represented by the abstracted virtual model 110. The health scores 116 may include overall system-level health scores, component-based health scores (e.g., based on the components 112), enterprise-context health scores, or a combination thereof. As an example, the digital twin platform 102 may generate a first health score corresponding to a first component of the components 112 by comparing one or more values corresponding to the first component to a portion of enterprise metadata and performance metrics and generating the first health score based on the comparison. The enterprise metadata and performance metrics may indicate expected outputs by the first component, historical outputs of the physical system 150 that map to the first component, target metrics for performance of the first component, or the like. For example, if the first component models a user account database, the digital twin platform 102 may compare a value that maps to account use during a time period to one or more account use thresholds to determine a first health score. As another example, if the first component models battery use at a wireless sensor, the digital twin platform 102 may compare a battery usage rate during a time period to one or more battery usage thresholds to determine the first health score. In some implementations, some of the health scores 116 may be based on others of the health scores 116. For example, a finance health score may be based on a billing system exception score, a customer payment rate, and the like.

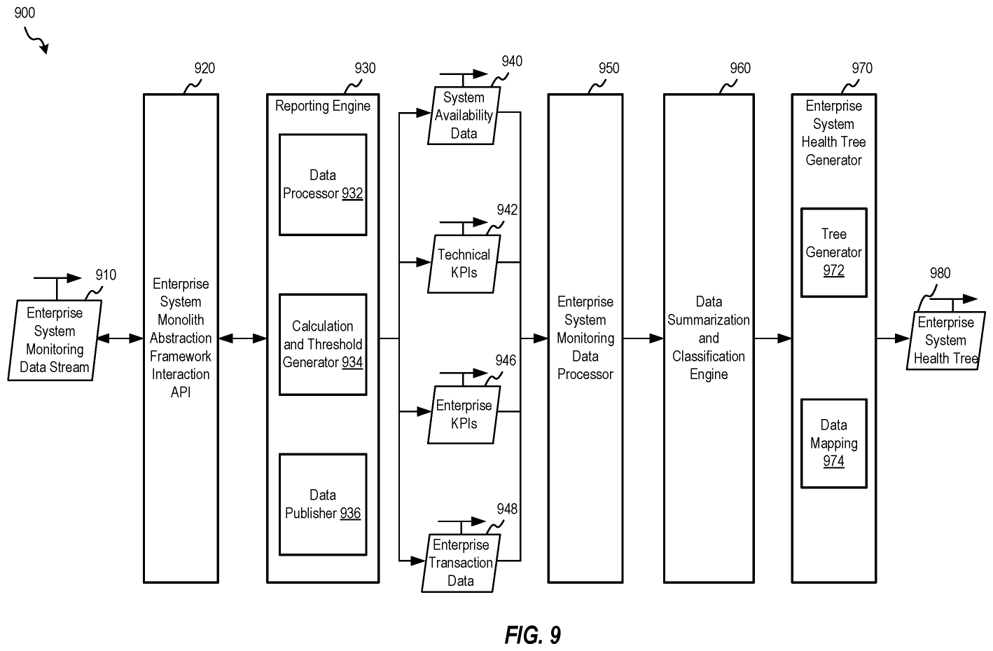

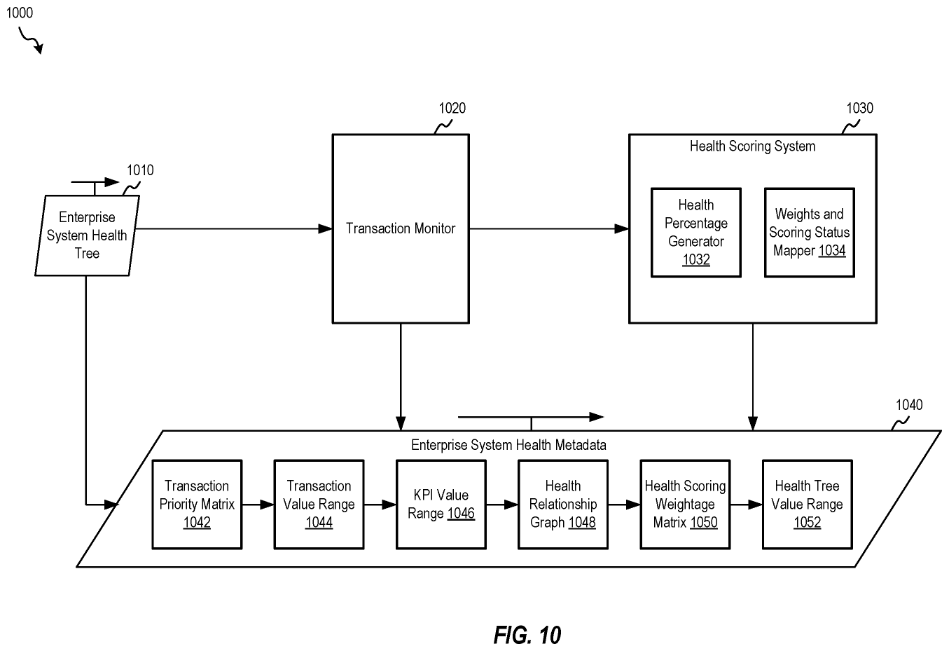

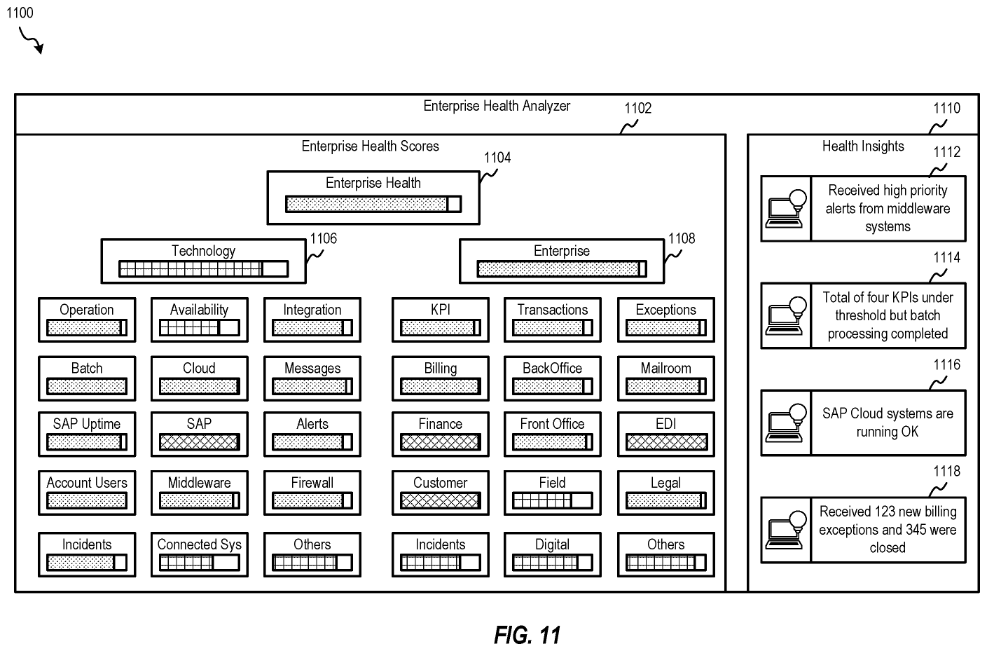

The digital twin platform 102 (e.g., the health monitoring and insights engine 129) may leverage the abstracted virtual model 110 and the health scores 116 to generate one or more outputs for providing to a user of the digital twin platform 102. The outputs may include one or more reports 170, a health GUI 172, one or more insights 174, other outputs, or a combination thereof, that may be provided to a user, such as by sending to a client device, displaying via a display device or a client device, using as the basis for one or more instructions to other systems or devices, or the like. The one or more reports 170 may include an enterprise report (e.g., a business report) based on the abstracted virtual model 110. In some implementations, the reports 170 may include or indicate system availability information, enterprise KPIs, technical KPIs, enterprise transactions, or a combination thereof. Additional details of reporting based on abstracted virtual models and health scores is described further herein with reference to FIG. 9. The health GUI 172 (e.g., a system health GUI) may include or indicate the health scores 116 and may represent relationships between the components 112 and/or the related health scores. Additional details of generating a health GUI are described further herein with reference to FIG. 10, and an example GUI is described with reference to FIG. 11.

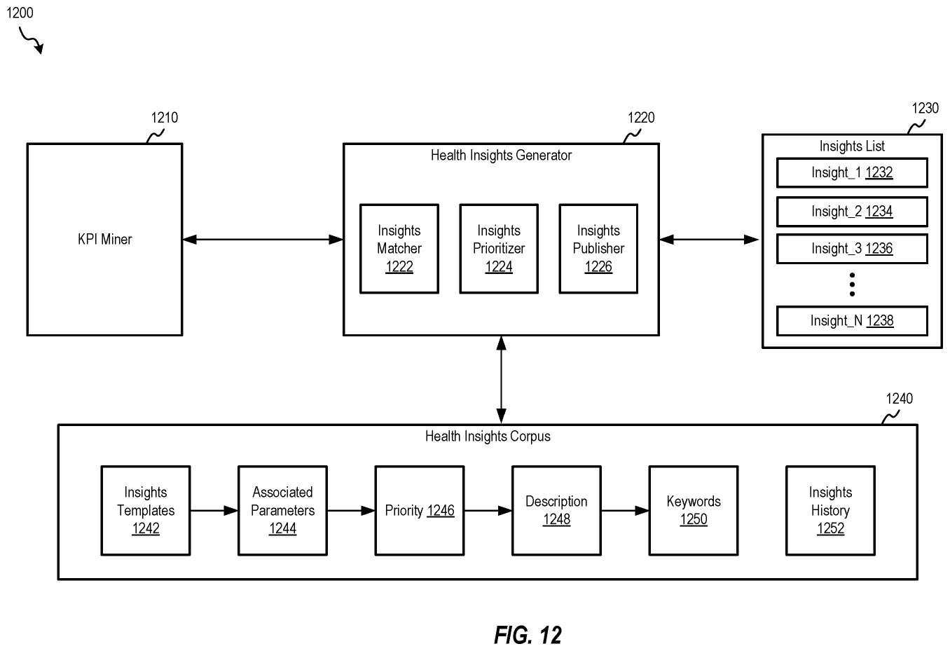

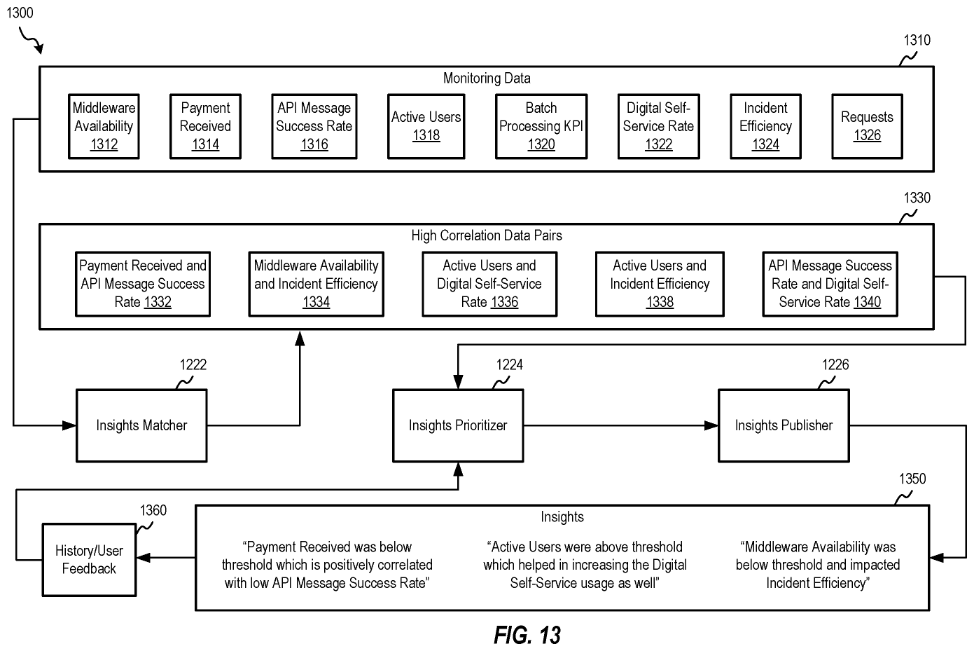

The insights 174 may represent highly correlated transactions (e.g., operations, events, etc., of the physical systems 150 that map to transactions of the components 112) identified using the abstracted virtual model 110, particularly highly correlated transaction pairs that have a strong affect on the health scores 116. To derive the insights 174, the digital twin platform 102 (e.g., the health monitoring and insights engine 129) may identify transactions indicated by processing the input data 114 and the abstracted virtual model 110 during a time period and determine correlation scores for pairs of the transactions. After determining the correlation scores, the digital twin platform 102 may determine relationship scores between the pairs of the transactions and an overall or target health score (e.g., one or more of the health scores 116), and, based on the determined scores, the digital twin platform 102 may identify one or more highly correlated transaction pairs having correlation scores that satisfy a first threshold and relationship scores that satisfy a second threshold. As a non-limiting example, it may be determined that payments received being below a corresponding threshold correlates positively with a low API message success rate, and that this highly correlated pair has a relationship score to a finance health (or an overall system health) that satisfies a relationship threshold. The insights 174 may be generated based on the identified highly correlated transaction pairs with strong relationship to system health. In some implementations, the digital twin platform 102 may generate the insights 174 by performing natural language processing (NLP) on the transactions of the identified highly correlated transaction pairs with strong relationship to system health to generate text that indicates a relationship between the transactions. For example, if the first transaction is payments received being low and the second transaction is low API message success rate, using NLP to process the two transactions may generate text such as “Payments received failing to satisfy a threshold correlates positively with low API message success rate.” In some other implementations, the digital twin platform 102 may generate the insights 174 by applying the identified highly correlated transaction pairs with strong relationship to system health to one or more insight text templates. For example, the insight text templates may include one or more keyword or key phrases to match to the transactions of the pair and other text, such as linking text, grammar-based text, or the like, such that application of the transactions to the template generates a text output similar to as described above for the NLP implementation. In some other implementations, a combination of NLP and insight text templates may be used to generate the insights 174. Additional details of generating insights based on processing of input data and abstracted virtual models is described further herein with reference to FIGS. 12-13.

In a particular implementation, a system (e.g., 100) for creating and leveraging digital twins of physical systems of enterprises is disclosed. The system includes a memory (e.g., 106) and one or more processors (e.g., 104) communicatively coupled to the memory. The one or more processors are configured to generate an abstracted virtual model (e.g., 110) of a computing system of an enterprise. The abstracted virtual model corresponds to a plurality of physical systems (e.g., 150) of the enterprise that are communicatively coupled via one or more networks. The abstracted virtual model is logically organized as a monolithic system including a plurality of components (e.g., 112) that are mapped to the plurality of physical systems. The abstracted virtual model defines relationships, dependencies, and attributes corresponding to the plurality of components. The one or more processors are also configured to obtain monitoring data (e.g., 160) from the plurality of physical systems. The one or more processors are configured to map the monitoring data to input data (e.g., 114) to update the plurality of components of the abstracted virtual model. The one or more processors are further configured to output health scores (e.g., 116) corresponding to one or more components of abstracted virtual model after the update.

As described above, the system 100 supports creating and leveraging digital twins of multiple distinct physical systems of enterprises that provides benefits compared to other digital twins. For example, by modelling the physical systems 150 as the abstracted virtual model 110 that is logically organized as a single monolithic system, relationships and dependencies between various computer systems that are isolated may be identified and leveraged to determine system health at a variety of granularities and in the context of the enterprise as a whole, instead of just from a technology perspective. In some implementations, the digital twin platform 102 may identify the insights 174, such as highly correlated parameters or events, particularly ones that have a strong effect on system health. The system health monitoring and insights provided by use of the abstracted virtual model 110 also take into account the relationship of the physical systems 150 to the operations of the enterprise as a whole, such that the abstracted virtual model 110 acts as a digital twin of a monolithic computer system and while also representing the relationship between the physical systems 150 and the enterprise as a whole (e.g., in view of business objectives, key performance indicators, and the like). Thus, the insights 174 and information (e.g., the reports 170 and/or the health GUI 172) that are based on the abstracted virtual model 110 enable members of the enterprise to make more meaningful decisions to improve system health, achieve enterprise goals, or the like. In some implementations, the monitoring data 160 from the physical systems 150 is mapped to the input data 114 using agent-controlled ML models (e.g., the ML models 126 and the agent 128), such that the mappings are adaptable to changing situations and to improve performance of the abstracted virtual model 110 with respect to one or more targets. As such, the mapping of the monitoring data 160 to the input data 114 may have improved performance as compared to using a static, predefined mapping, and without requiring periodic updating of the ML models 126 by a data scientist or other technician.

As such, the system 100 of FIG. 1 provides an innovative architecture for creating a monolithic digital twin for highly distributed collections of systems which as a group serve a larger role for the enterprise. For example, the abstracted virtual model 110 may represent a monolithic digital twin of an enterprise system and associated key components (e.g., the components 112). The abstracted virtual model 110 defines various relationships, dependencies, and attributes associated with each of the components 112, and these are mapped to the physical systems 150 and associated parameters. The abstracted virtual model 110 may be defined based on a monolith enterprise system model that describes the components 112 in a structured way and also provides a guided method that can be followed for different industries and different IT system configurations. The abstracted virtual model 110 (e.g., a composable virtual model of the physical systems 150) is logically organized as a monolithic enterprise system model that provides a digital twin-like experience of older monolithic computing systems and applications, thereby providing greater insights, analytics, and decision making than digital twins of any of the physical systems 150. The system 100 also provides an architecture and methods for generating a health tree and scoring (e.g., the health GUI 172 and the health scores 116, respectively) based on the abstracted virtual model 110 that is a representation of the physical systems 150. Additionally, the system 100 supports generating the insights 174 based on the monitoring data 160 and the abstracted virtual model 110, which includes KPI mining to identify highly-correlated information for use in generating the insights 174.

Referring to FIG. 2, an example of a system that supports a digital twin of a computer system of an enterprise according to one or more aspects is shown as a system 200. The system 200 includes a digital twin platform 202 that is communicatively coupled to a plurality of physical systems (referred to herein as computer system 260). In some implementations, the system 200 includes or corresponds to the system 100 (or portions thereof). For example, the digital twin platform 202 may include or correspond to the digital twin platform 102 of FIG. 1, and the computer system 260 may include or correspond to the physical systems 150 of FIG. 1.

The digital twin platform 202 may include one or more layers, modules, engines, and/or frameworks that support creation and processing of abstracted virtual models, such as a monolithic abstraction of interconnected systems that serve a broader function of an enterprise. In the example shown in FIG. 2, the digital twin platform 202 includes a model processing engine 210, an abstraction framework 230, and an enterprise system API layer 250. The enterprise system API layer 250 may be configured to support interaction between the computer system 260 (or interfaces thereof) and the digital twin platform 202 (e.g., a model and associated attributes maintained by the abstraction framework 230). In some implementations, the enterprise system API layer 250 includes an enterprise system transaction framework 252, events/alerts 254, system and custom APIs 256, log aggregator APIs 258, and a KPI framework 259. The enterprise system transaction framework 252 may define one or more transactions that correspond to operations performed by the computer system 260 for the enterprise, the events/alerts 254 may include one or more events or alerts detected or output by the computer system 260, and the KPI framework 259 may define one or more KPIs for the enterprise (e.g., one or more business goals, one or more KPIs related to the computer system 260 that achieve or promote the business goals, or the like). The system and custom APIs 256 may include one or more APIs configured to enable interaction with the abstraction framework 230 (e.g., the enterprise system model 234), and the log aggregator APIs 258 may include one or more APIs configured to receive, generate, maintain, and/or aggregate logs for the digital twin platform 202.

The abstraction framework 230 (e.g., an intelligent composable enterprise systems abstraction framework) may be configured to create and maintain an enterprise-focused virtual model of a monolithic system that can be mapped to a plurality of physical systems or microsystems. In some implementations, the abstraction framework 230 includes an enterprise system corpus 232, an enterprise system model 234, an enterprise system abstraction layer 236, an enterprise system mapper 238, an enterprise system KPI repository 240, and an enterprise system transaction repository 242. The enterprise system model 234 may include or correspond to a model that describes the various components and their relation in terms of a broader enterprise system context (e.g., an abstracted virtual model that describes the system in terms of one or more business goals. KPIs, or the like). The enterprise system corpus 232 may include a structured repository of the enterprise's functions and systems, including details and relational data for various levels (e.g., industry level, business segment level, business subsegment level, and associated business level), technology KPIs, business transactions, other information, or a combination thereof. In some implementations, the enterprise system corpus 232 represents a data repository described or defined by the enterprise system model 234. The enterprise system abstraction layer 236 may be an interface between the enterprise system model 234 and enterprise system API layer 250 to feed the various attributes' information into the enterprise system model 234 at runtime. The enterprise system mapper 238 may be an intelligent mapping module configured to map monitoring data from the computer system 260 to the enterprise system model 234 at runtime. The enterprise system KPI repository 240 may include a collection of relevant enterprise system KPIs, including definitions, relationships, and any associated logic. The enterprise system transaction repository 242 may include a collection of relevant enterprise system transactions associated with the enterprise system model 234.

The model processing engine 210 may be configured to leverage an abstracted virtual model to generate insights, provide a holistic operational vie, perform KPI mining, perform other analytics operations, or a combination thereof. In some implementations, the model processing engine 210 includes a report generator 212, a health tree generator 214, an enterprise system health scorer 216, a health insights generator 218, a KPI miner 220, a simulation engine 222, and an advisor 224. The report generator 212 may convert raw data from the enterprise system model 234 into a presentation model and create a UI layer to display the data to one or more users. The health tree generator 214 may generate a graphical hierarchical tree that represents the overall interrelation between various components of the enterprise system model 234 and how the components contribute to the overall health of the connected enterprise system (e.g., the computer system 260). The enterprise system health scorer 216 may determine health scoring of individual components of the enterprise system model 234 and their dependent components based on predefined a metadata repository and dynamic observations received from the enterprise system abstraction layer 236. The health insights generator 218 may generate system health-related insights with based on KPI mining information and the enterprise system corpus 232. The health insights generator 218 may also rank and sort the insights and display one or more high ranking insights to the users. The KPI miner 220 may identify highly correlated monitoring transactions or events from historical data. The simulation engine 222 (e.g., an intelligent simulation engine) may analyze and predict the overall impacts of the connected enterprise system based on changes infused into the enterprise system model 234. The advisor 224 (e.g., an intelligent advisor) may advise the users on different action items to improve overall system health or achieve other goals, through data-driven analysis and recommendations based on results from the simulation engine 222.

The computer system 260 includes or corresponds to a collection of multiple physical systems that are configured to perform individual operations and that, when viewed together, also serve to achieve one or more larger goals than the individual operations (e.g., one or more business goals). The computer system 260 may include any number or type of different devices, systems, applications, and the like that are distributed across a single or multiple locations and that may be at least partially under the control of multiple entities. In a particular, non-limiting example shown in FIG. 2, the computer system 260 includes software as a service (SaaS) solutions 262, cloud applications 264, enterprise resource planning (ERP) system 266, middleware 268, batch control 270, on-premises systems 272, IoT/sensors 274, and other systems 276. In other implementations, the computer system 260 may include fewer than eight components, more than eight components, and/or different components than shown in FIG. 2.

During operation, the digital twin platform 202 may be configured to create and maintain an abstracted virtual model (e.g., the enterprise system model 234) that represents the computer system 260 (e.g., a plurality of physical systems) but is logically organized as a monolithic system. In some implementations, the enterprise system model 234 may include or correspond to the abstracted virtual model 110 of FIG. 1. The enterprise system API layer 250 may enable communication between the digital twin platform 202 and the computer system 260, such as receipt of streaming monitoring data from the computer system 260, and the enterprise system mapper 238 may map the monitoring data to input data for the enterprise system model 234. The model processing engine 210 may perform one or more operations to analyze the monitoring data and the enterprise system model 234 to generate outputs to users of the system 200, such as reports, a system health tree, health insights, action items, or a combination thereof.

Referring to FIG. 3, an example of a system that supports a digital twin of a computer system of an enterprise according to one or more aspects is shown as a system 300. In some implementations, the system 300 of FIG. 3 includes or correspond to the system 100 of FIG. 1 or the system 200 of FIG. 2. For example, the system 300 of FIG. 3 may illustrate a data-driven arrangement of the system 200 of FIG. 2.

In the example shown in FIG. 3, the system 300 includes one or more enterprise system modules 302, an enterprise system model 310 (e.g., a monolithic digital twin), an enterprise system abstraction layer 320, an enterprise system mapper 330, and distributed IT systems 340. In this example, the enterprise system modules 302, the enterprise system model 310, the enterprise system abstraction layer 320, and the enterprise system mapper 330 may be included or integrated within a digital twin platform, such as the digital twin platform 102 of FIG. 1 or the digital twin platform 202 of FIG. 2. The enterprise system modules 302 may be configured to create and maintain the enterprise system model 310. In some implementations, the enterprise system modules 302 include an enterprise system corpus 304, an enterprise system KPI repository 306, and an enterprise system transaction repository 308. The enterprise system corpus 304 may include a structured repository of the enterprise's functions and systems, including details and relational data for various levels (e.g., industry level, business segment level, business subsegment level, and associated business level), technology KPIs, business transactions, other information, or a combination thereof. The enterprise system KPI repository 306 may include a collection of relevant enterprise system KPIs, including definitions, relationships, and any associated logic. The enterprise system transaction repository 308 may include a collection of relevant enterprise system transactions associated with the enterprise system model 310. In some implementations, the enterprise system corpus 304, the enterprise system KPI repository 306, and the enterprise system transaction repository 308 include or correspond to the enterprise system corpus 232, the enterprise system KPI repository 240, and the enterprise system transaction repository 242, respectively, of FIG. 2.

The enterprise system model 310 may include an abstracted virtual model that is logically organized as a monolithic system but that represents a collection of multiple distinct physical systems. For example, the enterprise system model 310 may include or correspond to the abstracted virtual model 110 of FIG. 1 or the enterprise system model 234 of FIG. 2. The enterprise system model 310 may provide a virtual model of a monolithic enterprise system that can include multiple interconnected subsystems (e.g., components) and that serve an overall function (e.g., a business goal or function) of the enterprise. Attributes may be associated with the components, and a monitoring element may be attached to the enterprise system model 310 to enable system health monitoring. In some implementations, the enterprise system model 310 includes an enterprise system graph 312, enterprise system technical attributes 314, and enterprise system functional attributes 316. The enterprise system graph 312 may be a graphical representation of the relationship and connections between the components (e.g., subsystems) of the enterprise system model 310. The enterprise system technical attributes 314 and the enterprise system functional attributes 316 may include technical attributes and functional, enterprise-related (e.g., business) attributes of the components, respectively. The enterprise system technical attributes 314 and the enterprise system functional attributes 316 may be exposed through one or more APIs and capable of being updated in real time (or near-real time), which in turn updates the enterprise system model 310.

The enterprise system abstraction layer 320 may be configured to support interaction between the distributed IT systems 340 (or interfaces thereof) and the enterprise system model 310 (and the associated enterprise system technical attributes 314 and the enterprise system functional attributes 316). In some implementations, the enterprise system abstraction layer 320 includes one or more enterprise system interaction APIs 322. The enterprise system interaction APIs 322 may enable updating of the enterprise system technical attributes 314, the enterprise system functional attributes 316, or both, based on mapped monitoring data from the distributed IT systems 340.

The enterprise system mapper 330 is configured to feed “real-world” data into the enterprise system model 310 through the enterprise system abstraction layer 320. To illustrate, the enterprise system mapper 330 may be configured to map monitoring data from the distributed IT systems 340 into input data for the enterprise system model 310. In some implementations, the enterprise system mapper 330 includes an enterprise system data mapper 332, an enterprise system data consumer 334, and an enterprise system data streamer 336. The enterprise system data streamer 336 may be configured to manage the receipt of streaming monitoring data from the distributed IT systems 340, the enterprise system data consumer 334 may be configured to consume and filter or otherwise normalize the data received by the enterprise system data streamer 336, and the enterprise system data mapper 332 may be configured to perform the mapping of the data to the input data for the enterprise system model 310 through the enterprise system interaction APIs 322. Additional details of mapping monitoring data to input data are described further herein with reference to FIG. 4.

The distributed IT systems 340 include or correspond to a collection of multiple physical systems that are configured to perform individual operations and that, when viewed together, also serve to achieve one or more larger goals of the enterprise (e.g., one or more business purposes). The distributed IT systems 340 may include multiple different devices, systems, applications, and the like distributed across one or more locations, as described above with reference to the physical systems 150 of FIG. 1 or the computer system 260 of FIG. 2. In some implementations, the distributed IT systems 340 include data interfaces 342 and IT systems 352. The data interfaces 342 may include one or more APIs or interfaces that expose the IT systems 352 and enable communication of output data, such as streaming monitoring data, from the distributed IT systems 340. In some implementations, the data interfaces 342 include a logging platform API 344, a database API 346, a system API 348, and other interfaces 350. In other implementations, the data interfaces 342 may include fewer than four or more than four APIs or interfaces, and/or different APIs or interfaces than are shown in FIG. 3. The IT systems 352 may include a system monitor 354 that is configured to monitor operations of one or more components of the IT systems 352 and may be exposed by the data interfaces 342 to enable communication of monitoring data generated by the system monitor 354.

During operation, the system 300 supports receipt of structured and non-structured information about a system landscape (e.g., a plurality of physical systems, such as the distributed IT system 340) having a plurality of documents including the enterprise system corpus 304, the enterprise system KPI repository 306, and the enterprise system transaction repository 308 for use in generating the enterprise system model 310 through a semi-guided process that includes mapping physical system parameters from the distributed IT systems 340 to the enterprise system model 310. The enterprise system model 310 may have a plurality of attributes to describe the model, including the enterprise system graph 312, the enterprise system technical attributes 314, and the enterprise system functional attributes 316. In some implementations, the enterprise system model 310 may be exposed to the enterprise system abstraction layer (e.g., the enterprise system interaction API 322) by use of an intelligent module powered by AI and/or ML (e.g., the enterprise system mapper 330), which enables interfacing between the distributed IT systems 340 and the attributes of the enterprise system model 310. For example, the enterprise system mapper 330, which includes the enterprise system data mapper 332, the enterprise system data consumer 334, and the enterprise system data streamer 336, may map the monitoring data received from the distributed IT systems 340 (e.g., the system monitor 354) via the data interfaces 342 to input data for the enterprise system model 310 in real time (or near-real time). The data interfaces 342 may have a plurality of APIs, such as the logging platform API 344, the database API 346, the system API 348, and the other interfaces 350, to enable communication and access to the monitoring data from the system monitor 354. Mapping the monitoring data from the data interfaces 342 to a format for input to the enterprise system interaction API 322 enables the system 300 to support generation and updating of the enterprise system model 310 for use in monitoring system health, generating reports, and generating insights to enable users of the system 300 to make meaningful decisions to improve or maintain system health while also achieving larger goals of the enterprise (e.g., one or more business objectives).

Referring to FIG. 4, an example of a system that supports an agent-based ML framework for mapping outputs of a physical system to a digital twin according to one or more aspects is shown as a system 400. In some implementations, the system 400 may include or correspond to one or more components of the system 100 of FIG. 1, the system 200 of FIG. 2, or the system 300 of FIG. 3, such as the digital twin platform 102 and the physical systems 150 of FIG. 1, the digital twin platform 202 and the computer system 260 of FIG. 2, or the digital twin platform (e.g., the enterprise system modules 302, the enterprise system model 310, the enterprise system abstraction layer 320, and the enterprise system mapper 330) and the distributed IT systems 340 of FIG. 3.

In the example shown in FIG. 4, the system 400 includes model abstraction and processing 402, an agent 410, an ML lookup 420, and distributed IT systems 440 (e.g., a plurality of physical systems). In this example, the model abstraction and processing 402, the agent 410, and the ML lookup 420 may be included in or integrated in a digital twin platform, such as the digital twin platform 102 of FIG. 1 or the digital twin platform 202 of FIG. 2. The distributed IT systems 440 may include or correspond to the distributed IT systems 340 of FIG. 3. For example, the distributed IT systems 440 may include data interfaces 442, which include a logging platform API 444, a database API 446, a system API 448, and other interfaces 449, and IT systems 452, which includes a system monitor 454, that include or correspond to the data interfaces 342 and the IT systems 353 of FIG. 3, respectively.

The model abstraction and processing 402 includes or corresponds to one or more components, modules, tools, information, or the like, that are configured to support creation, maintenance, and/or upgrading of an abstracted virtual model and processing of the model to generate outputs related to system health monitoring. In some implementations, the model abstraction and processing 402 includes a health tree 404, an enterprise system interaction API 406, and a mapping 408. The enterprise system interaction API 406 includes one or more APIs configured to expose the abstracted virtual model and associated attributes for updating based on the mapped input data, the mapping 408 indicates a mapping of the monitoring data received from the distributed IT systems 440 to input data for the abstracted virtual model, and the health tree 404 is one example of an output that may be generated from processing and updating the abstracted virtual model in the form of a GUI that shows components' health and relationships of the health to health of subcomponents in a visual manner. In some implementations, the mapping 408 is on a field-by-field basis (e.g., one or more fields of the monitoring data are mapped to one or more fields of the input data).

The agent 410 may be a reinforcement learning (RL) agent that is configured to recommend an action to the ML lookup 420 to improve the performance of the ML lookup 420 (e.g., to cause the ML lookup 420 to output mappings having one or more improved characteristics or parameters). To illustrate, the agent 410 may use a reward function that is based on one or more target characteristics or parameters for improvement in selecting the action to recommend. For example, the agent 410 may include an observation generator 412, a reward calculator 414, and a reinforcement (RL) model 416 (e.g., one or more trained neural networks or the like) that operate to recommend an action to be taken by the ML lookup 420, such as adding a new mapping, removing an existing mapping, modifying an existing mapping, or taking no action, as non-limiting examples. The observation generator 412 may be configured to generate an observation based on an input to the agent 410 (e.g., an output of the model abstraction and processing 402, such as the health tree 404 or value(s) derived therefrom), the reward calculator 414 may be configured to generate a reward based on the input and a reward function, and the RL model 416 may be trained to recommend an action that maximizes, optimizes, or achieves a target reward value for a corresponding observation, as further described below.

The ML lookup 420 includes or corresponds to a plurality of ML models (e.g., trained neural networks or the like) that are trained to map monitoring data from the distributed IT systems 440 to input data for the abstracted virtual model (e.g., to generate the mapping 408). In some implementations, the ML lookup 420 includes an association model 422, a similarity model 424, a data value model 426, and an ensemble model 428. Although four ML models are shown in the example of FIG. 4, in other implementations, the ML lookup 420 may include fewer than four or more than four ML models and/or differently trained ML models than shown in FIG. 4. Various ML models may be trained to recommend a mapping based on various parameters or characteristics. For example, the association model 422 may be trained to map the data based on associations between the fields, the similarity model 424 may be trained to map the data based on similarity between the fields, the data value model 426 may be trained to map the data based on data value or format characteristics, and the ensemble model 428 may be trained to output mappings based on the outputs of the ML models 422-426.

During operation of the system 400, the ML lookup 420 may recommend the mapping 408 that maps the monitoring data received from the distributed IT systems 440 to the input data format of the enterprise system interaction API 406. The mapped input data may be used to update the abstracted virtual model and/or associated attributes, and this process may be monitored to generate one or more system health outputs, such as the health tree 404. Additionally, the agent 410 may receive outputs based on the abstracted virtual model, such as the health tree 404 (or values derived therefrom) and, based on this information, recommend an action to improve performance of the ML lookup 420 (e.g., to improve a resulting characteristic or parameter in output data that is based on model updating using the mappings output by the ML lookup 420). In this manner, the system 400 implements a reinforcement learning technique to achieve a self-maintained data mapping architecture for mapping between data of multiple physical systems to data for an abstracted virtual model that is logically organized as a monolithic system. Although the mapping described with reference to FIG. 4 is in the context of mapping from distributed IT systems to a monolithic enterprise system model, the mapping techniques and systems described herein may be used for mapping between other types of systems and models that benefit from the adaptability of dynamic, real time (or near-real time) mapping with RL-based performance improvement.

Depending on the operational state of the monolithic model, the agent 410 may recommend actions to improve performance with respect to one or more characteristics or parameters, such as health tree coverage, validation error, calculation error, missing data, or the like. The agent 410 may be trained to improve, maximize, or optimize one or more parameters, such as data coverage of the platform, and therefore reduce or minimize data poverty. In some implementations, the operational planning of the data mapping solution may be formulated as a sequential decision-making problem using a Markov decision process (MDP). As such, the reinforcement learning problem is defined by an MDP that is defined by its d-dimensional state space S⊂ [symbol] ^{d}, action space A⊂ [symbol] , transition function ƒ, and cost function ρ. The MDP may be considered as a deterministic MDP with a finite optimization horizon of T time steps. At each time step y, based on the outcome of the action α_{y} ∈ A, the monolithic model evolves from state s_{y} ∈S to state s_{y+1} ∈S according to ƒ, according to Equation 1 below.

s_{y+1}=ƒ(s_{y},α_{y}),∀k∈{0,1,2, . . . T−1} Equation 1—Model State Transition

Each state transition step has an associated cost signal, according to Equation 2 below.

c_{y}=ρ(s_{y},α_{y}),∀k∈{0,1,2, . . . T−1} Equation 2—State Transition Cost Signal

For the action space, the agent 410 may take one of the actions based on the state of the monolithic model for any fields. The actions include α ∈{0,1, . . . n} where: α=0: map the field; α=1: remove mapping for the field; α=2 change mapping for the field; α=3 no action.

In some implementations, the agent 410 may use a reward function that is dependent on individual awards associated with target parameters, such as calculation error, missing data, validation error, and coverage analysis. For example, the reward function may correspond to a sum of the calculation error reward, the missing data reward, the validation error reward, and the coverage analysis reward. Calculation error refers to a measure associated with the number of secondary data elements with underlying calculation logics based on primary data failing (e.g., having errors). A greater number of calculation errors indicates a poor data mapping and hence negatively impacts the health of the system. A reward function related to calculation error may be determined according to Equation 3 below, where r_{cal} is the reward associated with the calculation error and Cₑ is the calculation error.

r_{cal}=ƒ(Cₑ) Equation 3—Calculation Error Reward Function

Missing data refers to an amount of missing data elements in the mapped input data. A large quantity of missing data indicates a poor data mapping state. A reward function related to missing data may be determined according to Equation 4 below, where rₘᵢₛ is the reward associated with the missing data and Dₘ is a measure of the missing data.

rₘᵢₛ=ƒ(Dₘ) Equation 4—Missing Data Reward Function

Validation error refers to failed data cross validation error. Validation error also impacts the overall quality of the solution and greater validation error indicates poor mapping performance. A reward function related to validation error may be determined according to Equation 5 below, where vᵣ is the reward associated with the validation error and vₑ is the validation error.

vᵣ=ƒ(vₑ) Equation 5—Validation Error Reward Function

Coverage analysis refers to the amount or scope of coverage in the health tree 404 (or other outputs based on the abstracted virtual model). Better coverage in the health tree indicates a more efficient data mapping. A reward function related to coverage analysis may be determined according to Equation 6 below, where Cᵣ is the reward associated with the coverage analysis and Cₐ is the coverage analysis.

Cᵣ=ƒ(Cₐ) Equation 6—Coverage Analysis Reward Function

In some implementations, the overall reward function may be based on a sum of the individual rewards. For example, the total calculated reward may be the sum of each individual reward multiplied by a factor to condition the resultant value within a target range. The overall reward function may be determined according to Equation 7 below, where rₜₒₜₐₗ is the total calculated reward.

rₜₒₜₐₗ=ƒ(r_{cal},rₘᵢₛ,vᵣ,Cᵣ) Equation 7—Overall Reward Function

In some implementations, the agent 410 (e.g., the observation generator 412, the reward calculator 414, and the RL model 416) may operate according to Algorithm 1 below in order to output recommended actions to improve the performance of the ML lookup 420.

Algorithm 1 - Intelligent Data Transformation Agent

Input: control period T, digital twin platform state sₜ, action a = (a₁, a₂, ... , aₙ}

| | |
|---|---|
| 1. | Generate observation from the state information oₜ = f (sₜ, aₜ₋₁) |
| 2. | Calculate reward rₜ |
| 3. | RL algorithm identifies the next best action aₜ₊₁ to move closer to the desired digital |

twin platform state

| | |
|---|---|
| 4. | If next best action is determined as alerting or requiring user support send callout |
| 5. | Continue monitoring the digital twin platform to detect user action |
| 6. | Resolve callout request |
| 7. | Agent resumes monitoring the digital twin platform integrations |
| 8. | End |

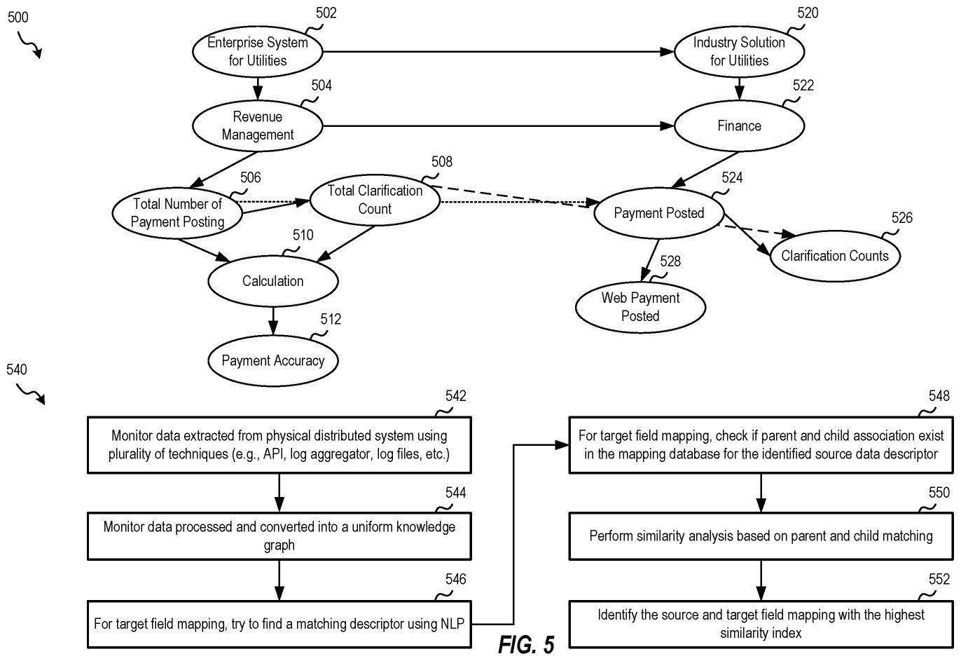

Referring to FIG. 5, a process flow of an example of a method for mapping output fields to input fields based on association according to one or more aspects is shown as a method 540 and a related example is shown as an example 500. In some implementations, the method 540 may be performed by a computing device that supports or interacts with an integrated virtual model (e.g., a digital twin), such as the digital twin platform 102 of FIG. 1, the digital twin platform 202 of FIG. 2, the digital twin platform of FIG. 3 (e.g., the enterprise system modules 302, the enterprise system model 310, the enterprise system abstraction layer 320, and/or the enterprise system mapper 330), the digital twin platform of FIG. 4 (e.g., the model abstraction and processing 402, the agent 410, and the ML lookup 420).

The example 500 includes monitoring data that is to be mapped to input data for an abstracted virtual model that is logically organized as a monolithic system. The fields of the monitoring data include a first field 502 (“Enterprise System for Utilities”), a second field 504 (“Revenue Management”), a third field 506 (“Total Number of Payment Posting”), a fourth field 508 (“Total Clarification Count”), a fifth field 510 (“Calculation”), and a sixth field 512 (“Payment Accuracy”), and the fields of the input data include a seventh field 520 (“Industry Solution for Utilities”), an eighth field 522 (“Finance”), a ninth field 524 (“Payment Posted”), a tenth field 526 (“Clarification Counts”), and an eleventh field 528 (“Web Payment Posted”). The fields of the monitoring data and the fields of the input data are illustrated in FIG. 5 according to hierarchical (e.g., parent-child) arrangements. For example, the first field 502 is a parent of the second field 504, the second field 504 is a child of the first field 502 and a parent of the third field 506, the third field 506 is a child of the second field 504 and a parent of the fourth field 508 and the fifth field 510, the fourth field 508 is a child of the third field 506 and a parent of the fifth field 510, the fifth field 510 is a child of the third field 506 and the fourth field 508 and a parent of the sixth field 512, and the sixth field 512 is a child of the fifth field 510. To further illustrate, the seventh field 520 is a parent of the eighth field 522, the eighth field 522 is a child of the seventh field 520 and a parent of the ninth field 524, the ninth field 524 is a child of the eighth field 522 and a parent of the tenth field 526 and the eleventh field 528, the tenth field 526 is a child of the ninth field 524, and the eleventh field 528 is a child of the tenth field 526. Parent and child relationships of fields may be stored in a mapping database for use in mapping, or subsequent improvement of mapping, of the data fields.

The fields of the monitoring data (e.g., the fields 502-512) may be mapped to the fields of the input data (e.g., the fields 520-528) according to the method 540. The method 540 includes monitoring data extracted from a physical distributed system using a plurality of techniques, at 542. The plurality of techniques may include API monitoring, log aggregators, log files, or the like. The method 540 includes monitoring data processed and converted into a uniform knowledge graph (e.g., an abstracted virtual model), at 544. The method 540 includes, for a target field mapping, trying to find a matching descriptor using NLP, at 546. For example, NLP operations may be performed on the names of the fields, and fields that exactly match or are sufficiently similar (e.g., have a threshold number of words, letters, characters, patterns, etc. in common) may be identified as matches. The method 540 includes, for the target field mapping, checking if a parent and child association exists in the mapping database for an identified source data descriptor, at 548. For example, if the first field 502 is mapped to the seventh field 520 (e.g., based on matching descriptors from NLP operations), as part of determining whether to map the second field 504 to the eighth field 522, the mapper may determine whether the eighth field 522 is a child of the field (e.g., the seventh field 520) that is mapped to the parent field (e.g., the first field 502) of the second field 504. The method 540 includes performing similarity analysis based on parent and child matching, at 550. For example, based on a determination that the parent of the second field 504 is mapped to a parent of the eighth field 522, a similarity analysis may be performed to compare the second field 504 to the eighth field 522 to determine a similarity index between the two fields. The method 540 includes identifying the source and target field mapping with the highest similarity index, at 552. For example, the second field 504 may be mapped to the eighth field 522 based on the similarity index between these two fields being higher than similarity indices for the second field 504 with other fields, particularly ones with a matching descriptor or matching parent and child association. Similarly, the third field 506 may be mapped to the ninth field 524 based on similarity of descriptors and parent-child associations, and the fourth field 508 may be mapped to the tenth field 526 based on similarity of descriptors and parent-child associations.

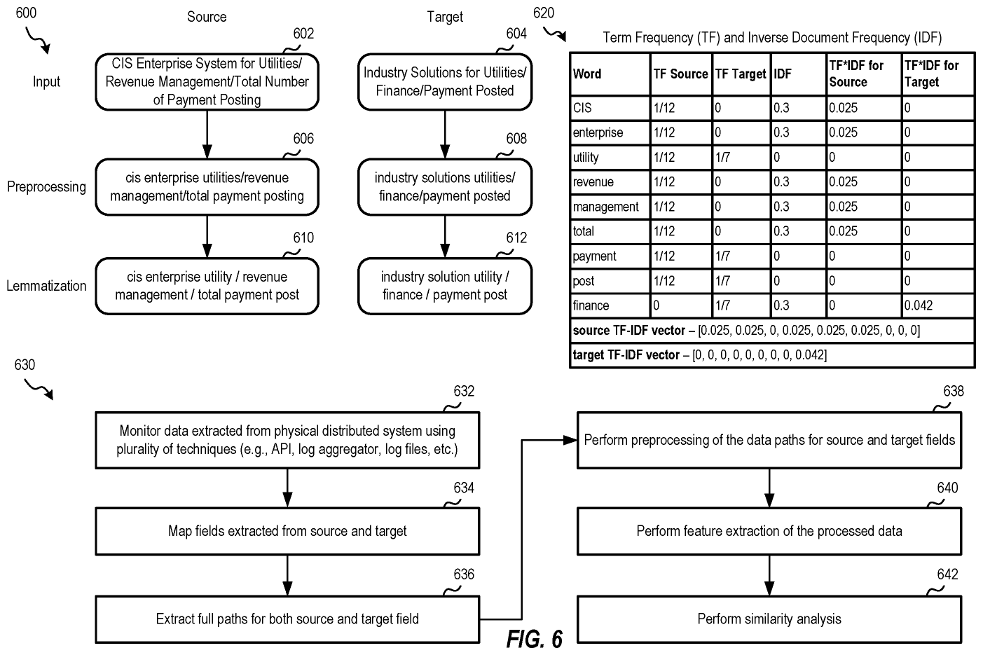

Referring to FIG. 6, a process flow of an example of a method for mapping output fields to input fields based on similarity according to one or more aspects is shown as a method 630 and a related example is shown as an example 600. In some implementations, the method 630 may be performed by a computing device that supports or interacts with an integrated virtual model (e.g., a digital twin), such as the digital twin platform 102 of FIG. 1, the digital twin platform 202 of FIG. 2, the digital twin platform of FIG. 3 (e.g., the enterprise system modules 302, the enterprise system model 310, the enterprise system abstraction layer 320, and/or the enterprise system mapper 330), or the digital twin platform of FIG. 4 (e.g., the model abstraction and processing 402, the agent 410, and the ML lookup 420).

The example 600 includes text of one or more fields from each of a source and a target (e.g., monitoring data and input data, respectively). In some implementations, the text is extracted paths for a field of the monitoring data (e.g., source data) and a field of the input data (e.g., target data). For example, source input text 602 includes the text “CIS Enterprise System for Utilities/Revenue Management/Total Number of Payment Posting”, and target input text 604 includes “Industry Solutions for Utilities/Finance/Payment Posted”. In order to determine whether to recommend mapping one or more fields indicated by the source input text 602 to one or more fields indicated by the target input text 604, NLP may be performed on the source input text 602 and the target input text 604. Text similarity is a technique of NLP which is used to find the “closeness” between two chunks of text by meaning or surface. The similarity analysis can be performed by applying pre-processing, determining word embeddings, generating feature vectors based on the word embeddings, and determining vector similarity between feature vectors for two text chunks. For example, such similarity analysis may be performed on the source input text 602 and the target input text 604. In some implementations, the preprocessing includes removing stop words, converting text to lower case, and removing non-ASCII characters. In other implementations, the preprocessing may include fewer than three or more than three preprocessing operations and/or different preprocessing operations. To illustrate, performing preprocessing on the source input text 602 generates source preprocessed text 606 “cis enterprise utilities/revenue management/total payment posting”, and performing preprocessing on target input text 604 generates target preprocessed text 608 “industry solutions utilities/finance/payment posted”. After the text is preprocessed, feature extraction operations may be performed on the preprocessed text. In some implementations, the feature extraction operations include performing lemmatization on the preprocessed text, determining term frequency (TF) and inverse document frequency (IDF) values based on the lemmatized text, and generating a TF-IDF vector that includes the determined values. For example, performing lemmatization on the source preprocessed text 606 and the target preprocessed text 608 generates source lemmatized text 610 “cis enterprise utility/revenue management/total payment post” and target lemmatized text 612 “industry solution utility/finance/payment post”, respectively. After the text is lemmatized, TF-IDF values and TF-IDF vectors may be determined, with the results being shown in TF-IDF table 620. For example, a source TF-IDF vector based on the source lemmatized text 610 is [0.025, 0.025, 0, 0.025, 0.025, 0.025, 0, 0, 0] and a target TF-IDF vector based on the target lemmatized text 612 is [0, 0, 0, 0, 0, 0, 0, 0, 0.042]. To determine the similarity, a cosine similarity value may be determined based on the feature vectors (e.g., TF-IDF vectors).

Input text chunks and target text chunks may be determined according to the method 630. The method 630 includes monitoring data extracted from a physical distributed system using a plurality of techniques, at 632. The plurality of techniques may include API monitoring, log aggregators, log files, or the like. The method 630 includes mapping fields extracted from source and target, at 634. For example, the mapping described with reference to the example 600 may be performed to map monitoring data from the physical distributed system to input data for an abstracted virtual model. The method 630 includes extracting full paths for both source and target fields, at 636. For example, the paths may be extracted as the source input text 602 and the target input text 604. The method 630 includes performing preprocessing of the data paths for the source and target fields, at 638. For example, performing the preprocessing may generate the source preprocessed text 606 and the target preprocessed text 608. The method 630 includes performing feature extraction of the processed data, at 640. For example, performing the feature extraction may include performing lemmatization to generate the source lemmatized text 610 and the target lemmatized text 612, determining the TF-IDF values (e.g., the feature values), and extracting the feature values to generate the feature vectors (e.g., the TF-IDF vectors). The method 630 also includes performing similarity analysis, at 642. For example, a recommendation whether to map a field of monitoring data to a field of input data may be based on whether a cosine similarity value derived from the source feature vector and the target feature vector satisfies a threshold.

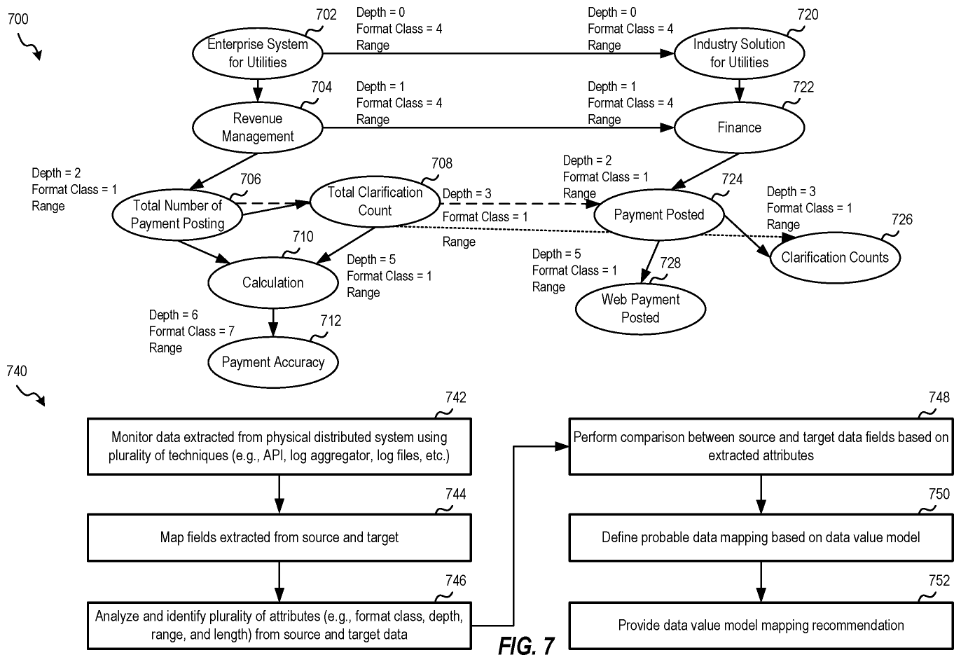

Referring to FIG. 7, a process flow of an example of a method for mapping output fields to input fields based on data values according to one or more aspects is shown as a method 740 and a related example is shown as an example 700. In some implementations, the method 740 may be performed by a computing device that supports or interacts with an integrated virtual model (e.g., a digital twin), such as the digital twin platform 102 of FIG. 1, the digital twin platform 202 of FIG. 2, the digital twin platform of FIG. 3 (e.g., the enterprise system modules 302, the enterprise system model 310, the enterprise system abstraction layer 320, and/or the enterprise system mapper 330), or the digital twin platform of FIG. 4 (e.g., the model abstraction and processing 402, the agent 410, and the ML lookup 420).

The example 700 includes monitoring data that is to be mapped to input data for an abstracted virtual model that is logically organized as a monolithic system. The fields of the monitoring data include a first field 702 (“Enterprise System for Utilities”), a second field 704 (“Revenue Management”), a third field 706 (“Total Number of Payment Posting”), a fourth field 708 (“Total Clarification Count”), a fifth field 710 (“Calculation”), and a sixth field 712 (“Payment Accuracy”), and the fields of the input data include a seventh field 720 (“Industry Solution for Utilities”), an eighth field 722 (“Finance”), a ninth field 724 (“Payment Posted”), a tenth field 726 (“Clarification Counts”), and an eleventh field 728 (“Web Payment Posted”). The fields of the monitoring data and the fields of the input data are illustrated in FIG. 7 according to hierarchical (e.g., parent-child) arrangements. For example, the first field 702 is a parent of the second field 704, the second field 704 is a child of the first field 702 and a parent of the third field 706, the third field 706 is a child of the second field 704 and a parent of the fourth field 708 and the fifth field 710, the fourth field 708 is a child of the third field 706 and a parent of the fifth field 710, the fifth field 710 is a child of the third field 706 and the fourth field 708 and a parent of the sixth field 712, and the sixth field 712 is a child of the fifth field 710. To further illustrate, the seventh field 720 is a parent of the eighth field 722, the eighth field 722 is a child of the seventh field 720 and a parent of the ninth field 724, the ninth field 724 is a child of the eighth field 722 and a parent of the tenth field 726 and the eleventh field 728, the tenth field 726 is a child of the ninth field 724, and the eleventh field 728 is a child of the tenth field 726. Parent and child relationships of fields may be stored in a mapping database for use in mapping, or subsequent improvement of mapping, of the data fields.

Data value analysis may be based on comparisons of data value similarities between the fields. Data values may be compared by comparing one or more parameters of the fields relating to data stored by the fields, such as a depth, a format class, a range, other parameters, or a combination thereof. For the example 700, data values may have different format classes as described in Table 1 below.

TABLE 1
Data Value Types

| Data Value Type | Description | Format Class | Example |
|---|---|---|---|
| Integer | Information contains | 1 | 89009 |
| | digits 0-9 | | |
| Decimal | Digits separated by | 2 | 89.98 |
| | decimal places | | |
| Alphabets | Characters with no | 3 | Billing |
| | spaces | | |
| Text | Characters with | 4 | Billing |
| | spaces | | Accuracy |
| Formatted | Digits with | 5 | 10,000 |
| Numbers | punctuation marks | | |
| Text-Number | Characters, numbers, | 6 | Total = 2345 |
| | and spaces | | |
| Alphanumerical | Characters and digits | 7 | ORD12345 |
| Other | Anything else | 8 | |

Depth may refer to refer to an order of the field within a text chunk or other source (e.g., the result of performing NLP on a full path of a field, as described above with reference to FIG. 6). Range may refer to a range of permissible values stored by the field. In the example 700, the first field 702 has a depth of 0, a format class of 4, and a particular range, the second field 704 has a depth of 1, a format class of 4, and a particular range, the third field 706 has a depth of 2, a format class of 1, and a particular range, the fourth field 708 has a depth of 3, a format class of 1, and a particular range, the fifth field 710 has a depth of 5, a format class of 1, and a particular range, the sixth field 712 has a depth of 6, a format class of 7, and a particular range, the seventh field 720 has a depth of 0, a format class of 4, and a particular range, the eighth field 722 has a depth of 1, a format class of 4, and a particular range, the ninth field 724 has a depth of 2, a format class of 1, and a particular range, the tenth field 726 has a depth of 3, a format class of 1, and a particular range, and the eleventh field 728 has a depth of 5, a format class of 1, and a particular range. Additional data value attributes for the fields 702-708 and 720-726 are given by Tables 2 and 3 below, and the attributes may be extracted and compared to determine whether to recommend mapping a source field (e.g., of the monitoring data) to a target field (e.g., of the input data).

TABLE 2
Example Source Data Value Attributes

| | | Format | | | |
|---|---|---|---|---|---|
| Field | Source | Class | Range | Max Length | Depth (n) |
| First | CIS | 4 | N/A | 150 | N = 0 |
| | Enterprise | | | | |
| | System for | | | | |
| | Utilities | | | | |
| Second | Revenue | 4 | N/A | 150 | N > 0 |
| | Management | | | | |
| Third | Total | 1 | >4000 | 4 | N > 2 |
| | Number of | | | | |
| | Payment | | | | |
| | Posting | | | | |
| Fourth | Total | 1 | <300 | 3 | N > depth of |
| | Clarification | | | | third field |
| | Count | | | | |

TABLE 3
Example Target Data Value Attributes

| | | Format | | | |
|---|---|---|---|---|---|
| Field | Target | Class | Range | Max Length | Depth (n) |
| Seventh | Industry | 4 | N/A | 150 | 0 |
| | Solutions for | | | | |
| | Utilities | | | | |
| Eighth | Finance | 4 | N/A | 150 | 1 |
| Ninth | Payment | 1 | 4096 | 4 | 2 |
| | Posted | | | | |
| Tenth | Clarification | 1 | 215 | 3 | 3 |
| | Counts | | | | |

The fields of the monitoring data (e.g., the fields 702-712) may be mapped to the fields of the input data (e.g., the fields 720-728) according to the method 740. The method 740 includes monitoring data extracted from a physical distributed system using a plurality of techniques, at 742. The plurality of techniques may include API monitoring, log aggregators, log files, or the like. The method 740 includes mapping fields extracted from source and target, at 744. For example, the mapping described with reference to the example TX( ) may be performed to map monitoring data from the physical distributed system to input data for an abstracted virtual model. The method 740 includes analyzing and identifying a plurality of attributes from source and target data, at 746. The plurality of attributes may include format class, depth, range, and length. For example, the attributes may be analyzed to determine the values included in Table 2 and Table 3. The method 740 includes performing a comparison between the source and target data fields based on the extracted attributes, at 748. For example, the attributes in Table 2 and Table 3 may be compared on an attribute-by-attribute basis to determine a data value similarity between the source field and the target field. The method 740 includes defining a probable data mapping based on the data value model, at 750. For example, the data value similarity between the source field and the target field may be compared to data value similarities for other combinations of the source field and different target fields. The method 740 also includes providing a data value model mapping recommendation, at 752. For example, a mapping recommendation may be based on a source-target field pair having the highest data value similarity for each source field or each target field. In some implementations, the above-described data value mapping may be performed according to Algorithm 2 below.

Algorithm 2 - Data Value Mapping Model

Input: mapping target path P, input collection of values IP = [i, InputPath]

| | |
|---|---|
| 1. | for each row i in IP do |
| 2. | Calculate target parent path mapping with source parent paths |
| 3. | for each mapped fields |
| 4. | MappingWeight = MappingWeight + 1 |
| 5. | end |
| 6. | Calculate the input fields with maximum MappingWeight with the |
| | target fields |
| 7. | End |

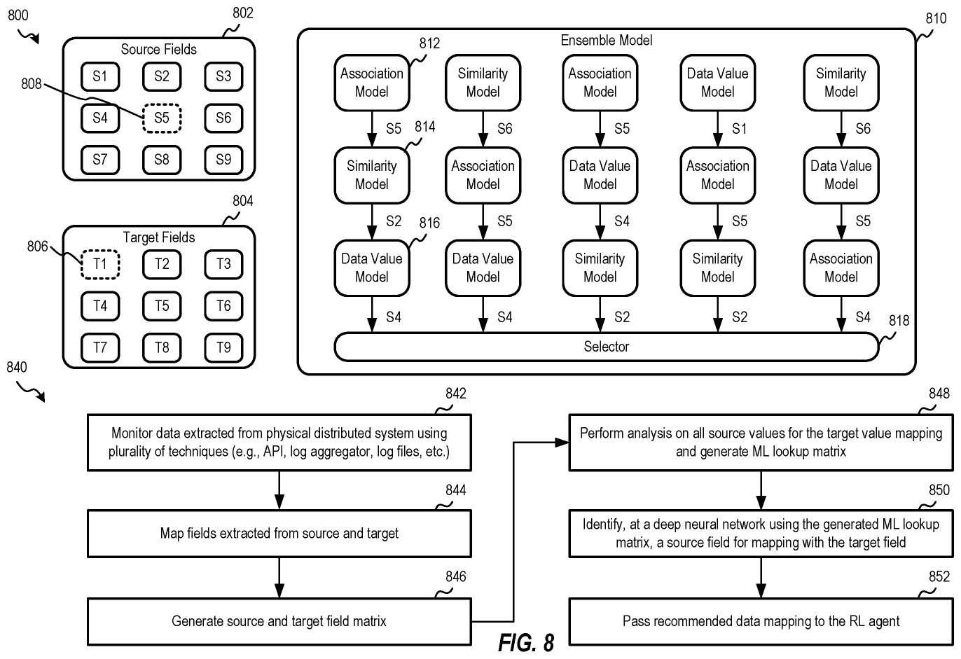

Referring to FIG. 8, a process flow of an example of a method for mapping output fields to input fields based on an ensemble model according to one or more aspects is shown as a method 840 and a related example is shown as an example 800. In some implementations, the method 840 of FIG. 8 may be performed by a computing device that supports or interacts with an integrated virtual model (e.g., a digital twin), such as the digital twin platform 102 of FIG. 1, the digital twin platform 202 of FIG. 2, the digital twin platform of FIG. 3 (e.g., the enterprise system modules 302, the enterprise system model 310, the enterprise system abstraction layer 320, and/or the enterprise system mapper 330), or the digital twin platform of FIG. 4 (e.g., the model abstraction and processing 402, the agent 410, and the ML lookup 420).

In some implementations, generating a final mapping recommendation for source fields (e.g., monitoring data) to target fields (e.g., input data) may be performed using an ensemble of differently trained ML models, which may be controlled by an RL agent, as described above with reference to FIG. 4. In the example 800, fields extracted from source text (e.g., text from monitoring data, such as paths) may be identified and organized as a source field matrix 802, and fields extracted from target text (e.g., text from input data to an abstracted virtual model) may be identified and organized as a target field matrix 804. Each target field of the target field matrix 804 may be mapped to a source field of the source field matrix 802 using an ensemble model 810. The ensemble model 810 may be trained to output a recommended mapping for target fields to source fields (or source fields to target fields) based on recommended mappings from each of a plurality of different ML models. For example, the ensemble model 810 may include a plurality of ML models, such as one or more ML models trained to operate as described with reference to FIG. 5 (e.g., illustrative association model 812), one or more ML models trained to operate as described with reference to FIG. 6 (e.g., illustrative similarity model 814), and one or more ML models trained to operate as described with reference to FIG. 7 (e.g., illustrative data value model 816), in addition to a selector 818. Although fifteen ML models are shown in the example of FIG. 8, in other implementations, the ensemble model 810 may include fewer than fifteen or more than fifteen ML models and/or other types of ML models. In some implementations, the ML models of the ensemble model 810 may be organized into multiple ML model chains that each include an association model, a similarity model, and a data value model, although the ordering of the ML models may be different for different ML model chains.

Each ML model is trained to recommend a mapping for an input field based on the corresponding type of mapping. For example, if the ensemble model 810 receives identification of a first target field 806 (“T1”) as in input, the association model 812 may recommend a mapping to source field S5 based on association between S5 and T1, the similarity model 814 may recommend a mapping to source field S2 based on similarity between S2 and T1, and the data value model 816 may recommend a mapping to source field S4 based on data value similarity between S4 and T1. Each ML model of the ensemble model 810 may output a recommendation in a similar manner, which recommendations from different ML models of the same type potentially being different due to different training sets, different parameters or hyperparameters of the ML models, or the like. The selector 818 may be configured to receive the outputs of the ML models and to generate a recommended mapping based on the outputs. For example, the selector 818 may select the source field that is most recommended by the ML models (e.g., a mode). Alternatively, the selector 818 may assign weights to each ML model, each type of ML model, or each ML model chain, and the selection may be a weighted selection. In some implementations, the selector 818 may include one or more ML models, such as a deep neural network, that is trained to learn weightings for the other ML models based on a training set for use in performing a weighted selection. In the example shown in FIG. 8, the selector 818 may output a recommendation mapping of the first target field 806 to a fifth source field 808 (“S5”) based on S5 being the most recommended mapping from the individual ML models of the ensemble model 810.

This ensemble-based mapping may be performed according to the method 840. The method 840 includes monitoring data extracted from a physical distributed system using a plurality of techniques, at 842. The plurality of techniques may include API monitoring, log aggregators, log files, or the like. The method 840 includes mapping fields extracted from source and target, at 844. For example, the mapping described with reference to the example 800 may be performed to map monitoring data from the physical distributed system to input data for an abstracted virtual model (or input data fields to monitoring data fields). The method 840 includes generating a source field matrix and a target field matrix, at 846. For example, the extracted fields may be organized into the source field matrix 802 and the target field matrix 804. The method 840 includes performing analysis on all source values for the target value mapping and generating an ML lookup matrix, at 848. For example, the ensemble model 810 may be configured to recommend a mapping for a target field from the target field matrix 804 to one of the source fields of the source field matrix 802. The method 840 includes identifying, at a deep neural network using the generated ML lookup matrix, a source field for mapping with the target field, at 850. For example, the ensemble model 810 may select the fifth source field 808 to be mapped to the first target field 806 based on recommendations from a plurality of different ML models. The method 840 also includes passing the recommended data mapping to the RL agent, at 852. For example, the mapping recommended by the ensemble model 810 may be used to map fields between the monitoring data and the input data for the abstracted virtual model, and the mapping may be provided to an RL agent for determining a recommendation to improve the mapping, as described above with reference to FIG. 4.

Referring to FIG. 9, an example of a system that uses an abstracted virtual model of a monolithic system to provide reporting and a system health tree according to one or more aspects is shown as a system 900. In some implementations, the system 900 may include or correspond to one or more components of the system 100 of FIG. 1, the system 200 of FIG. 2, the system 300 of FIG. 3, or the system 400 of FIG. 4, such as the digital twin platform 102 of FIG. 1, the digital twin platform 202 of FIG. 2, the digital twin platform (e.g., the enterprise system modules 302, the enterprise system model 310, the enterprise system abstraction layer 320, and the enterprise system mapper 330) of FIG. 3, or the digital twin platform of FIG. 4 (e.g., the model abstraction and processing 402, the agent 410, and the ML lookup 420).

In the example shown in FIG. 9, the system 900 includes an enterprise system monolith abstraction framework interaction API 920, a reporting engine 930, an enterprise system monitoring data processor 950, a data summarization and classification engine 960, and an enterprise system health tree generator 970. The enterprise system monolith abstraction framework interaction API 920 may include one or more APIs that are configured to communicate with multiple physical systems of an enterprise, such as a collection of distributed physical systems, to receive monitoring data and map the monitoring data to input data of an abstracted virtual model that is logically organized as a monolithic system, as described above with reference to FIGS. 1-8. For example, the enterprise system monolith abstraction framework interaction API 920 may receive an enterprise system monitoring data stream 910 and map the received data to input data for the abstracted virtual model. The reporting engine 930 may be configured to process the mapped data and the abstracted virtual model to generate metrics and data for use in reporting system health or other information to a user. In some implementations, the reporting engine 930 includes a data processor 932, a calculation and threshold generator 934, and a data publisher 936. The data processor 932 may be configured to process the data from the abstracted virtual model and the monitoring data to generate relevant processed data, the calculation and threshold generator 934 may be configured to calculate or generate thresholds for comparing the processed data to in order to monitor system health, and the data publisher 936 may be configured to output enterprise system data to be used to monitor system health.

The enterprise system data output by the reporting engine 930 may include metrics, transaction data, health data, availability data, other information, or a combination thereof, that is indicative of health of the components of the abstracted virtual model. In some implementations, the enterprise system data includes system availability data 940, technical KPIs 942, enterprise KPIs 946, and enterprise transaction data 948. The system availability data 940 may indicate, or may be used to determine, availability of IT systems to be reported, such as by a software agent. The technical KPIs 942 may include one or more metrics that gauge performance of underlying IT systems and processes over time. The enterprise KPIs 946 may include one or more metrics used to gauge the performance of the enterprise's operations over time. The enterprise transaction data 948 may include operational data from the physical systems, such as reported incidents, customer tool usage, and the like, and may be aggregated for use in monitoring system health.

The enterprise system monitoring data processor 950 may be configured to receive the data output by the reporting engine 930, such as the system availability data 940, the technical KPIs 942, the enterprise KPIs 946, and the enterprise transaction data 948, and to process the received data for analysis during system health monitoring. The data summarization and classification engine 960 may be configured to sort (e.g., split) the processed data by category and to normalize or summarize the portions of data for usage by the enterprise system health tree generator 970. The enterprise system health tree generator 970 may be configured to create an enterprise system health tree 980 based on the normalized and sorted data received from the data summarization and classification engine 960. The enterprise system health tree 980 may include or correspond to a GUI that provides a visual representation of a health tree for the monolithically organized system (e.g., a hierarchical model of overall system health and health of various components). To generate the enterprise system health tree 980, the enterprise system health tree generator 970 may calculate health scores and relationships for subsystems (e.g., components) of the abstracted virtual model. In some implementations, the enterprise system health tree 980 include a tree generator 972 configured to generate the enterprise system health tree 980 and data mapping 974 configured to map the normalized and sorted data from the data summarization and classification engine 960 to a format used by the tree generator 972. Additionally or alternatively, the enterprise system health tree generator 970 may be configured to perform correlation analysis on the normalized and sorted data to identify correlated transactions or other events for use in generating insights. In some implementations, the enterprise system monitoring data processor 950, the data summarization and classification engine 960, and the enterprise system health tree generator 970 may operate according to Algorithm 3 below to generate the enterprise system health tree 980.

Algorithm 3 - Enterprise System Health Tree Generation

Input: availability data and operation indicators

| 1. | Real time processing of systems data | |
|---|---|---|
| 2. | for each event do | |
| | 1. | Classify by type |
| | 2. | Normalize data |
| | 3. | Aggregate to summarized system information |

| | |
|---|---|
| 3. | end for |
| 4. | Update health data with summarized information |
| 5. | Generate health tree hierarchy with updated system data and |
| | configured system relationships |
| 6. | Process health tree using correlation analysis and record findings |
| 7. | Output generated enterprise system health tree for requested time |
| | period |

Referring to FIG. 10, an example of a system that generates health scores and a system health tree based on an abstracted virtual model according to one or more aspects is shown as a system 1000. In some implementations, the system 1000 may include or correspond to one or more components of the system 100 of FIG. 1, the system 200 of FIG. 2, or the system 300 of FIG. 3, such as the digital twin platform 102 of FIG. 1, the digital twin platform 202 of FIG. 2, the digital twin platform (e.g., the enterprise system modules 302, the enterprise system model 310, the enterprise system abstraction layer 320, and the enterprise system mapper 330) of FIG. 3, or the digital twin platform of FIG. 4 (e.g., the model abstraction and processing 402, the agent 410, and the ML lookup 420). For example, the system 1000 may include or correspond to the health monitoring and insights engine 129 of FIG. 1 or the model processing engine 210 of FIG. 2.

In the example shown in FIG. 10, the system 1000 includes a transaction monitor 1020 and a health scoring system 1030. The transaction monitor 1020 may be configured to perform correlation analysis on an enterprise system health tree 1010 (or values derived therefrom) to identify correlated transactions or other events. The health scoring system 1030 may be configured to receive identified transactions and the enterprise system health tree 1010 from the transaction monitor 1020 and to normalize health scores (e.g., generate health percentages) and to map transactions to weights or scores based on the generated percentages. In some implementations, the health scoring system 1030 includes a health percentage generator 1032 configured to generate the health percentages and a weights and scoring status mapper 1034 to map the transactions to weights or scores based on the health percentages. The enterprise system health metadata 1040 may include or correspond to a stream of processed readings from the transaction monitor 1020, portions of the enterprise system health tree 1010, and weights or scores from the health scoring system 1030 that are stored as metadata to be used as input for generating health scores by the health scoring system 1030, updating the enterprise system health tree 1010, or generating insights, as further described herein with reference to FIGS. 12-13. In some implementations, the enterprise system health metadata 1040 includes a transaction priority matrix 1042, a transaction value range 1044, a KPI value range 1046, a health relationship graph 1048, a health scoring weightage matrix 1050, and a health tree value range 1052. In other implementations, the enterprise system health metadata 1040 includes fewer than or more than six types of metadata or different metadata than shown in FIG. 10.

As described above with reference to FIG. 10, the system 1000 enables generation of a system health tree (e.g., the enterprise system health tree 1010) of an abstracted virtual model that represents a collection of physical systems. To illustrate, the system 1000 may generate the enterprise system health tree 1010 for an abstracted virtual model logically organized as a monolithic system by applying machine learning and advanced data processing techniques that include real time processing, data summarization, classification, and mapping utilizing a relationship matrix. Additionally, the health scoring system 1030 may utilize the enterprise system health metadata 1040, including the transaction priority matrix 1042, the transaction value range 1044, the KPI value range 1046, the health relationship graph 1048, the health scoring weightage matrix 1050, and the health tree value range 1052, to generate health scores for each individual component of the abstracted virtual model based on a function of dependent components' health score(s). Additionally, the health scoring system 1030 (e.g., the health percentage generator 1032) may normalize and convert the health scores into a percentile scale by utilizing the weights and scoring status mapper 1034.

Referring to FIG. 11, an example of a system health GUI according to one or more aspects is shown as a GUI 1100. In some implementations, the GUI 1100 may include or correspond to the health GUI 172 of FIG. 1, a health tree generated by the health tree generator 214 of FIG. 2, the health tree 404 of FIG. 4, the enterprise system health tree 980 of FIG. 9, or the enterprise system health tree 1010 of FIG. 10.

The GUI 1100 may display health information about the enterprise system that is modelled as an abstracted virtual model that is logically organized as a monolithic system to represent a collection of distributed physical systems, in addition to one or more system health insights. For example, the GUI 1100 may include enterprise system health scores 1102 and health insights 1110. The enterprise system health scores 1102 may include a plurality of health scores that correspond to the enterprise system as a whole or to various components or groupings of components of the enterprise system that are modelled by the abstracted virtual model. In some implementations, the enterprise system health scores 1102 may be hierarchically arranged to illustrate relationships or dependencies between the health scores and the components. For example, a first health score 1104 (“Enterprise Health”) of a first tier may correspond to an overall system health, and the first health score 1104 may be based on health scores from a second tier that is below the first tier. In this example, the second tier may include a second health score 1106 (“Technology”) and a third health score 1108 (“Enterprise”) that correspond to groupings of individual components' health scores on lower tiers. To further illustrate, the second health score 1106 may be based on a first plurality of component health scores, such as health scores for “Operation”. “Availability”, “Integration”, “Batch”, etc., and the third health score 1108 may be based on a second plurality of component health scores, such as “KPI”, “Transactions”, “Exceptions”, “Billing”, etc. In some implementations, each health score is indicated by a visual representation, such as a bar, a pie chart, a graph, a numerical percentage, or by some other visual representation. In a particular implementation, health scores' relationships to corresponding thresholds may be visually indicated. For example, health scores that are within a first range (e.g., that fail to satisfy a first threshold and a second threshold) may be indicated with a first color or pattern, such as the second health score 1106, health scores that are within a second range (e.g., that satisfy the first threshold but fail to satisfy the second threshold) may be indicated with a second color or pattern, such as the third health score 1108, and health scores that are within a third range (e.g., that satisfy the first threshold and the second threshold) may be indicated with a third color or pattern, such as the health score for the component “Finance.” In this example, the first range may correspond to health scores that require improvement, the second range may correspond to health scores that are within an acceptable range, and the third range may correspond to health scores that exceed expectations.

The health insights 1110 may include one or more insights that identify highly correlated transactions or components that are strongly related to system health or actions that can improve system health. The insights may be text that links a pair of highly correlated transaction or events of the components that have been determined to have a strong effect on system health, either positively or negatively. For example, the health insights 1110 may include a first insight 1112 (“Received high priority alerts from middleware systems”), a second insight 1114 (“Total of four KPIs under threshold but batch processing completed”), a third insight 1116 (“SAP cloud systems are running OK”), and a fourth insight 1118 (“Received 123 new billing exceptions and 345 were closed”). Although four insights are show-n, in other implementations, the health insights 1110 may include fewer than four or more than four insights. The health insights 1110 may be generated by identifying highly correlated pairs of transactions or events that are strongly related to system health, as further described herein with reference to FIGS. 12-13.

Referring to FIG. 12, an example of a system that uses an abstracted virtual model of a monolithic system to generate system health insights according to one or more aspects is shown as a system 1200. In some implementations, the system 1200 may include or correspond to one or more components of the system 100 of FIG. 1, the system 200 of FIG. 2, or the system 300 of FIG. 3, such as the digital twin platform 102 of FIG. 1, the digital twin platform 202 of FIG. 2, the digital twin platform (e.g., the enterprise system modules 302, the enterprise system model 310, the enterprise system abstraction layer 320, and the enterprise system mapper 330) of FIG. 3, or the digital twin platform of FIG. 4 (e.g., the model abstraction and processing 402, the agent 410, and the ML lookup 420).

In the example shown in FIG. 12, the system 1200 includes a KPI miner 1210, a health insights generator 1220, an insights list 1230, and a health insights corpus 1240. The KPI miner 1210 may be configured to mine (e.g., extract or identify) KPIs from outputs from an abstracted virtual model, such as health scores, operations data, reporting data, a health tree, and the like. The health insights generator may be configured to receive the KPIs and the outputs from the abstracted virtual model and to generate one or more insights that explain or improve system health, such as the insights list 1230. In some implementations, the health insights generator 1220 may include or correspond to the health monitoring and insights engine tor 129 of FIG. 1 or the health insights generator 218 of FIG. 2. In some implementations, the health insights generator 1220 includes an insights matcher 1222, an insights prioritizer 1224, and an insights publisher 1226. The insights matcher 1222 may be configured to evaluate the correlation of generated data pairs (e.g., transaction pairs, event pairs, etc.) and identify highly correlated data pairs. The insights prioritizer 1224 may be configured to mark highly correlated data pairs as priority if they have a high impact on system health (e.g., if the impact satisfies a threshold). The insights publisher 1226 may be configured to create user-friendly insights from the highly correlated data pairs that are marked priority. For example, the insights may be text that describes the correlated events and how the events affect system health. The insights list 1230 may include one or more insights generated by the health insights generator 1220. For example, the insights list 1230 may include a first insight 1232 (“Insight_1”), a second insight 1234 (“Insight_2”), a third insight 1236 (“Insight_3”), and a fourth insight 1238 (“Insight_N”). Each insight may include text that links transactions or events from highly correlated pairs that strongly affect system health. For example, the first insight 1232 may include or correspond to the first insight 1112, the second insight 1234 may include or correspond to the second insight 1114, the third insight 1236 may include or correspond to the third insight 1116, and the fourth insight 1238 may include or correspond to the fourth insight 1118 of FIG. 11. Although the insights list 1230 is shown in FIG. 12 as including four insights, in other implementations, the insights list 1230 may include fewer than four or more than four insights.

In some implementations, health insights generator 1220 may access a health insights corpus 1240 to generate insights based on the highly correlated data pairs that are marked priority. The health insights corpus 1240 may include information, such as insight templates, parameters, keywords, and the like, to assist the health insights generator 1220 in generating text chunks based on transactions or events named by the data pairs. Additionally or alternatively, the health insights corpus 1240 may include generated insights, or information associated with or indicative of the insights. In some implementations, the health insights corpus 1240 includes insight templates 1242, associated parameters 1244, priority information 1246, description 1248, keywords 1250, and insights history 1252. Although insights are described as being generated by applying the insight templates 1242 to transactions or events of highly correlated pairs, in some other implementations, insights may be identified by performing NLP operations on the transactions or events included in the identified data pairs, as further described above with reference to FIG. 1, instead of using preset templates.

As described above with reference to FIG. 12, the system 1200 supports generation of system health insights (e.g., the insights list 1230). To illustrate, the system 1200 uses the health insights generator 1220 (e.g., an insight generator processing pipeline) to generate meaningful qualitative narration of the system health from stored, quantitative time series data for attributes of an abstracted virtual model. The health insights generator 1220 may analyze the data to identify highly correlated data elements (e.g., transactions or events) which can be matched against the health insights corpus 1240, including the insights templates 1242, and further prioritized, published, and presented through a visualization engine (e.g., a system health GUI that includes the insights, as described above with reference to FIG. 11). In some implementations, the insights of the insights list 1230 may be generated according to Algorithm 4 below.

Algorithm 4 - Enterprise Operation to Insight Mapping

Input: event information from integration landscape

| 1. | Process monitoring event data | |
|---|---|---|
| 2. | for each event do | |
| | 1. | Calculate correlation to other events |
| | 2. | Create a pairing entry if event is highly correlated to |
| | | another event |

| | |
|---|---|
| 3. | end for |
| 4. | Evaluate high correlation data pairs and select priority insight items |
| | using ML model |
| 5. | Priority insights are parsed and prepared for display to the user |
| 6. | User provides feedback to reinforce insight ML model |
| 7. | Output operational insights |

Referring to FIG. 13, an example of providing health system insights according to one or more aspects is shown as an example 1300. The operations and insights described with reference to FIG. 13 may include or correspond to the insights 174 generated by the health monitoring and insights engine 129 of FIG. 1, insights generated by the health insights generator 218 of FIG. 2, or the insights list 1230 of FIG. 12.

In the example 1300, monitoring data 1310 that has been processed and analyzed using an abstracted virtual model may be received as input to the insights matcher 1222. The monitoring data 1300 may include information indicating one or more transactions, events, or the like, that were monitored to determine system health. As a non-limiting example, the monitoring data 1300 may include middleware availability 1312, payment received 1314, API message success rate 1316, active users 1318, batch processing KPI 1320, digital self-service rate 1322, incident efficiency 1324, and requests 1326. In some implementations, the information included in the monitoring data 1310 may include an indication of whether a corresponding transaction, event, etc., satisfies a particular threshold. For example, elements that fail to satisfy a corresponding threshold may be associated with a first indicator, such as a graphical indicator, a color, a font style, or the like, and elements that satisfy a corresponding threshold may be associated with a second indicator, such as a different graphical indicator, a different color, a different font style, or the like.

The insights matcher 1222 may analyze the monitoring data 1310 and identify highly correlated transaction pairs (e.g., pairs of transactions for which a correlation measurement satisfies a threshold). In the example 1300, the insights matcher 1222 may identify high correlation data pairs 1330 having five pairs: a first pair 1332 (the payment received 1314 and the API message success rate 1316), a second pair 1334 (the middleware availability 1312 and the incident efficiency 1324), a third pair 1336 (the active users 1318 and the digital self-service rate 1322), a fourth pair 1338 (the active users 1318 and the incident efficiency 1324), and a fifth pair 1340 (the API message success rate 1316 and the digital self-service rate 1322). The insights prioritizer 1224 may receive the high correlation data pairs 1330 and, based on an effect each pair has on system health, mark each of the pairs as priority if the pair has a strong effect on system health. In the example 1300, the insights prioritizer 1224 may mark first pair 1332, the second pair 1334, and the third pair 1336 as priority (and not the fourth pair 1338 or the fifth pair 1340). The insights publisher 1226 may generate insights 1350 based on the marked high correlation data pairs. For example, the insights 1350 may include “Payment Received was below threshold which is positively correlated with low API Message Success Rate,” “Active Users were above threshold which helped in increasing the Digital Self-Service usage as well,” and “Middleware Availability was below threshold and impacted Incident Efficiency.” In some implementations, after the insights 1350 are published, history/user feedback 1360 that indicates user response to the insights 1350 or historical insights may be used to improve the insights generated by the health insights generator 1220. For example, a user may provide feedback on the usefulness of a published insight (e.g., a prioritized insight item) to help the health insights generator 1220 learn and more easily recognize relevant correlated data pairs.

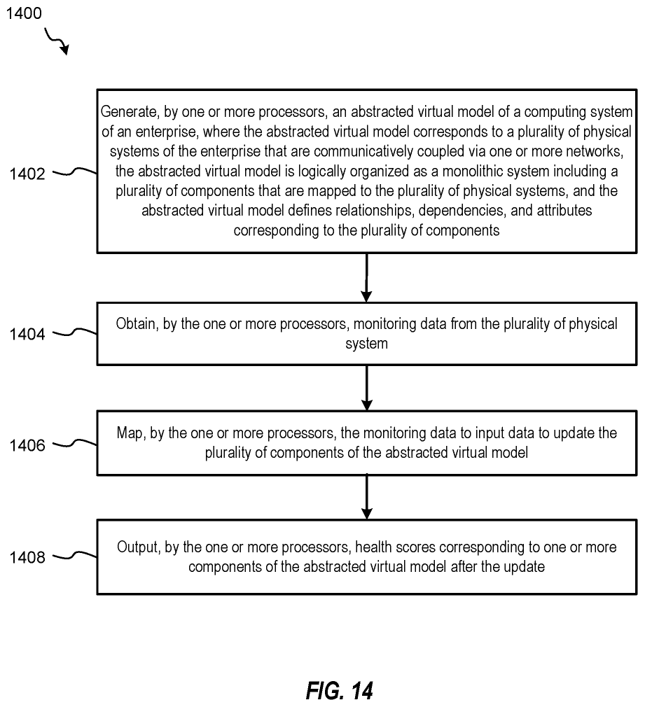

Referring to FIG. 14, a flow diagram of an example of a method for creating and leveraging digital twins of physical systems of enterprises according to one or more aspects is shown as a method 1400. In some implementations, the operations of the method 1400 may be stored as instructions that, when executed by one or more processors (e.g., the one or more processors of a computing device or a server), cause the one or more processors to perform the operations of the method 1400. In some implementations, the method 1400 may be performed by a computing device, such as the digital twin platform 102 of FIG. 1 (e.g., a computing device configured to host a digital twin), the digital twin platform 202 of FIG. 2, the digital twin platform (e.g., the enterprise system modules 302, the enterprise system model 310, the enterprise system abstraction layer 320, and the enterprise system mapper 330) of FIG. 3, the digital twin platform of FIG. 4 (e.g., the model abstraction and processing 402, the agent 410, and the ML lookup 420), the system 900 of FIG. 9, the system 100 of FIG. 10, the system 1200 of FIG. 12, or a combination thereof.

The method 1400 includes generating an abstracted virtual model of a computing system of an enterprise, at 1402. For example, the abstracted virtual model may include or correspond to the abstracted virtual model 110 of FIG. 1. The abstracted virtual model corresponds to a plurality of physical systems of the enterprise that are communicatively coupled via one or more networks. For example, the plurality of physical systems may include or correspond to physical systems 150 of FIG. 1. The abstracted virtual model is logically organized as a monolithic system comprising a plurality of components that are mapped to the plurality of physical systems. For example, the plurality of components may include or correspond to the components 112 of FIG. 1. The abstracted virtual model defines relationships, dependencies, and attributes corresponding to the plurality of components.

The method 1400 includes obtaining monitoring data from the plurality of physical systems, at 1404. For example, the monitoring data may include or correspond to the monitoring data 160 of FIG. 1. The method 1400 includes mapping the monitoring data to input data to update the plurality of components of the abstracted virtual model, at 1406. For example, the input data may include or correspond to the input data 114 of FIG. 1. The method 1400 includes outputting health scores corresponding to one or more components of the abstracted virtual model after the update, at 1408. For example, the health scores may include or correspond to the health scores 116 of FIG. 1.

In some implementations, the method 1400 further includes outputting an enterprise report based on the abstracted virtual model. The enterprise report includes system availability information, enterprise KPIs, technical KPIs, enterprise transactions, or a combination thereof. For example, the enterprise report may include or correspond to the reports 170 of FIG. 1. Additionally or alternatively, the method 1400 may include generating the health scores, where generating a first health score corresponding to a first component of the abstracted virtual model includes comparing one or more values corresponding to the first component to a portion of enterprise metadata and performance metrics. In this implementation, the method 1400 also includes generating the first health score based on the comparison. For example, the health scores may be generated as described above with reference to FIGS. 10-11. Additionally or alternatively, the method 1400 may also include outputting a health GUI that includes the health scores and that represents relationships between the plurality of components. For example, the health GUI may include or correspond to the health GUI 172 of FIG. 1.

In some implementations, the method 1400 further includes identifying transactions indicated by the input data and the abstracted virtual model during a time period, determining correlation scores for pairs of the transactions, determining relationship scores between the pairs of the transactions and an overall health score, and identifying one or more highly correlated transaction pairs having correlation scores that satisfy a first threshold and relationship scores that satisfy a second threshold. For example, the highly correlated transaction pairs may be identified as further described above with reference to FIGS. 12-13. In some such implementations, the method 1400 may also include outputting one or more insights based on the one or more highly correlated transaction pairs. For example, the one or more insights may include or correspond to the insights 174 of FIG. 1. In some such implementations, generating a first insight of the one or more insights includes performing NLP on a first transaction of a first highly correlated transaction pair and a second transaction of the first highly correlated transaction pair to generate text that indicates a relationship between the first transaction and the second transaction. Additionally or alternatively, generating a second insight of the one or more insights includes applying a second highly correlated transaction pair to one or more insight templates to generate text that indicates a relationship between a first transaction of the second highly correlated transaction pair and a second transaction of the second highly correlated transaction pair. For example, the insights may be generated as further described above with reference to FIGS. 12-13.

In some implementations, mapping the monitoring data to the input data includes providing the monitoring data to an ML model configured to map fields of the monitoring data to fields of the input data. For example, the ML model may include or correspond to the ML models 126 of FIG. 1. In some such implementations, the ML model includes an ensemble model configured to output a mapping recommendation based on a recommendation from a data value ML model, a recommendation from a similarity ML model, and a recommendation from an association ML model. For example, the ML model may include the configuration of ML models described above with reference to FIG. 4. Additionally or alternatively, the method 1400 may further include providing one or more outputs based on the abstracted virtual model as input to an agent configured to determine an action to take to improve the mapping performed by the ML model based on a reward function. For example, the agent may include or correspond to the agent 128 of FIG. 1. In some such implementations, the agent includes an RL model. Additionally or alternatively, the reward function may be based on calculation error associated with the one or more outputs, missing data associated with the one or more outputs, validation error associated with the one or more outputs, coverage scope associated with the one or more outputs, or a combination thereof, as further described above with reference to FIG. 4. Additionally or alternatively, the action may include one of adding a mapping of a field of the monitoring data to a field of the input data, removing the mapping of the field of the monitoring data to the field of the input data, modifying the mapping of the field of the monitoring data to the field of the input data, or taking no action, as further described above with reference to FIG. 4.

As described above, the method 1400 supports modelling multiple physical systems as an abstracted virtual model of a single monolithically-organized system. Such a model may illustrate relationships and dependencies between various computer systems that are isolated, and these relationships and dependencies may be leveraged to monitor system health at a variety of granularities. Additionally, insights such as highly correlated parameters or events may be identified, particularly ones that have a strong effect on system health, that would otherwise go unidentified without the logical organization of the abstracted virtual model. The system health monitoring and insights provided by the method 1400 also take into account the relationship of the physical systems to the operations of the enterprise as a whole, such that the abstracted virtual model acts as a digital twin of a monolithic computer system and represents the relationship between the system and the enterprise as a whole (e.g., in view of business objectives, key performance indicators, and the like). Thus, the insights and information that are based on the abstracted virtual model of the method 1400 enable members of the enterprise to make more meaningful decisions to improve system health, achieve enterprise goals, or the like.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It is noted that other types of devices and functionality may be provided according to aspects of the present disclosure and discussion of specific devices and functionality herein have been provided for purposes of illustration, rather than by way of limitation. It is noted that the operations of the method 1400 of FIG. 14 may be performed in any order, or that operations of one method may be performed during performance of another method, such as the method 1400 of FIG. 14 including one or more operations of the method 540 of FIG. 5, the method 630 of FIG. 6, the method 740 of FIG. 7, or the method 840 of FIG. 8. It is also noted that the method 1400 of FIG. 14 may also include other functionality or operations consistent with the description of the operations of the system 100 of FIG. 1, the system 200 of FIG. 2, the system 300 of FIG. 3, the system 400 of FIG. 4, the example 500 of FIG. 5, the example 600 of FIG. 6, the example 700 of FIG. 7, the example 800 of FIG. 8, the system 900 of FIG. 9, the system 1000 of FIG. 10, the GUI 1100 of FIG. 11, the system 1200 of FIG. 12, the example 1300 of FIG. 13, or a combination thereof.

Components, the functional blocks, and the modules described herein with respect to FIGS. 1-14) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically: two items that are “coupled” may be unitary with each other, the term “or,” when used in a list of two or more items, means that any one of the listed items may be employed by itself, or any combination of two or more of the listed items may be employed. For example, if a composition is described as containing components A, B, or C, the composition may contain A alone; B alone: C alone; A and B in combination; A and C in combination; B and C in combination; or A, B. and C in combination. Also, as used herein, including in the claims, “or” as used in a list of items prefaced by “at least one of” indicates a disjunctive list such that, for example, a list of “at least one of A. B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within[a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for creating and leveraging digital twins of physical systems of enterprises, the method comprising:
generating, by one or more processors, an abstracted virtual model of a computing system of an enterprise, wherein:
the abstracted virtual model corresponds to a plurality of physical systems of the enterprise that are communicatively coupled via one or more networks,
the abstracted virtual model is logically organized as a monolithic system comprising a plurality of components that are mapped to the plurality of physical systems, and
the abstracted virtual model defines relationships, dependencies, and attributes corresponding to the plurality of components;
obtaining, by the one or more processors, monitoring data from the plurality of physical systems;
mapping, by the one or more processors, the monitoring data to input data to update the plurality of components of the abstracted virtual model; and
outputting, by the one or more processors, health scores corresponding to one or more components of the abstracted virtual model after the update.

2. The method of claim 1, wherein the abstracted virtual model represents a digital twin of a monolithically organized computing system of an enterprise that corresponds to the plurality of physical systems.

3. The method of claim 1, wherein the abstracted virtual model comprises an application programming interface (API) layer configured to update the plurality of components based on the input data.

4. The method of claim 1, further comprising outputting an enterprise report based on the abstracted virtual model, the enterprise report comprising system availability information, enterprise key performance indicators (KPIs), technical KPIs, enterprise transactions, or a combination thereof.

5. The method of claim 1, further comprising generating the health scores, wherein generating a first health score corresponding to a first component of the abstracted virtual model comprises:
comparing, by the one or more processors, one or more values corresponding to the first component to a portion of enterprise metadata and performance metrics; and
generating, by the one or more processors, the first health score based on the comparison.

6. The method of claim 1, further comprising outputting, by the one or more processors, a health graphical user interface (GUI) that includes the health scores and that represents relationships between the plurality of components.

7. The method of claim 1, further comprising:
identifying, by the one or more processors, transactions indicated by the input data and the abstracted virtual model during a time period;
determining, by the one or more processors, correlation scores for pairs of the transactions;
determining, by the one or more processors, relationship scores between the pairs of the transactions and an overall health score; and
identifying, by the one or more processors, one or more highly correlated transaction pairs having correlation scores that satisfy a first threshold and relationship scores that satisfy a second threshold.

8. The method of claim 7, further comprising outputting, by the one or more processors, one or more insights based on the one or more highly correlated transaction pairs.

9. The method of claim 8, wherein generating a first insight of the one or more insights comprises performing, by the one or more processors, natural language processing (NLP) on a first transaction of a first highly correlated transaction pair and a second transaction of the first highly correlated transaction pair to generate text that indicates a relationship between the first transaction and the second transaction.

10. The method of claim 8, wherein generating a second insight of the one or more insights comprises applying, by the one or more processors, a second highly correlated transaction pair to one or more insight templates to generate text that indicates a relationship between a first transaction of the second highly correlated transaction pair and a second transaction of the second highly correlated transaction pair.

11. A system for creating and leveraging digital twins of physical systems of enterprises, the system comprising:
a memory; and
one or more processors communicatively coupled to the memory, the one or more processors configured to:
generate an abstracted virtual model of a computing system of an enterprise, wherein:
the abstracted virtual model corresponds to a plurality of physical systems of the enterprise that are communicatively coupled via one or more networks,
the abstracted virtual model is logically organized as a monolithic system comprising a plurality of components that are mapped to the plurality of physical systems, and
the abstracted virtual model defines relationships, dependencies, and attributes corresponding to the plurality of components;
obtain monitoring data from the plurality of physical systems;
map the monitoring data to input data to update the plurality of components of the abstracted virtual model; and
output health scores corresponding to one or more components of abstracted virtual model after the update.

12. The system of claim 11, wherein, to map the monitoring data to the input data, the one or more processors are configured to provide the monitoring data to a machine learning (ML) model configured to map fields of the monitoring data to fields of the input data.

13. The system of claim 12, wherein the ML model comprises an ensemble model configured to output a mapping recommendation based on a recommendation from a data value ML model, a recommendation from a similarity ML model, and a recommendation from an association ML model.

14. The system of claim 12, wherein the one or more processors are further configured to provide one or more outputs based on the abstracted virtual model as input to an agent configured to determine an action to take to improve the mapping performed by the ML model based on a reward function.

15. The system of claim 14, wherein the agent comprises a reinforcement learning (RL) model.

16. The system of claim 14, wherein the reward function is based on calculation error associated with the one or more outputs, missing data associated with the one or more outputs, validation error associated with the one or more outputs, coverage scope associated with the one or more outputs, or a combination thereof.

17. The system of claim 14, wherein the action comprises one of adding a mapping of a field of the monitoring data to a field of the input data, removing the mapping of the field of the monitoring data to the field of the input data, modifying the mapping of the field of the monitoring data to the field of the input data, or taking no action.

18. A non-transitory computer-readable storage medium storing instructions that, when executed by one or more processors, cause the one or more processors to perform operations for creating and leveraging digital twins of physical systems of enterprises, the operations comprising:
generating an abstracted virtual model of a computing system of an enterprise, wherein:
the abstracted virtual model corresponds to a plurality of physical systems of the enterprise that are communicatively coupled via one or more networks,
the abstracted virtual model is logically organized as a monolithic system comprising a plurality of components that are mapped to the plurality of physical systems, and
the abstracted virtual model defines relationships, dependencies, and attributes corresponding to the plurality of components;
obtaining monitoring data from the plurality of physical systems;
mapping the monitoring data to input data to update the plurality of components of the abstracted virtual model; and
outputting health scores corresponding to one or more components of abstracted virtual model after the update.

19. The non-transitory computer-readable storage medium of claim 18, wherein the abstracted virtual model represents a digital twin of a monolithically organized computing system of an enterprise that corresponds to the plurality of physical systems.

20. The non-transitory computer-readable storage medium of claim 18, outputting a health graphical user interface (GUI) that includes the health scores and that represents relationships between the plurality of components.
